(19) United States
(12) Patent Application Publication
(10) Pub. No.: US 2012/0101939 A1
(43) Pub. Date: Apr. 26, 2012

(54) METHOD AND SYSTEM FOR SECURE ONLINE PAYMENTS

(76) Inventor: Sheldon Kasower, West Hills, CA (US)

(21) Appl. No.: 13/269,317

(22) Filed: Oct. 7, 2011

Related U.S. Application Data
(63) Continuation-in-part of application No. 13/104,725, filed on May 10, 2011.
(60) Provisional application No. 61/406,335, filed on Oct. 25, 2010.

(51) Int. Cl. G06Q 40/02

(52) U.S. Cl. 705/39

(57) ABSTRACT

Methods and devices are provided for secure online payments. In one embodiment, the method may involve receiving log-in information for a user. The method may involve accessing data regarding open credit card accounts for the user from a credit card grantor/issuer and/or a credit information entity (e.g., a credit bureau), in response to the received log-in information matching stored authentication information. The method may involve sending secure account information about the open credit card accounts to at least one network entity (e.g., a registration server, a user device, or a merchant server). The method may also involve, in response to the user selecting a given one of the accounts from the secure account information, determining whether sufficient credit is available for the selected given account and processing a transaction with the selected given account.

### CROSS-REFERENCE TO RELATED APPLICATIONS

This application is a continuation-in-part of U.S. application Ser. No. 13/104,725, filed May 10, 2011, which claims to the benefit of U.S. Provisional Application No. 61/406,335, filed Oct. 25, 2010, each of which are hereby expressly incorporated in their entirety by reference herein.

### BACKGROUND

### 1. Field

The present application relates generally to online transactions, and more specifically to systems and methods for reducing the risk of credit card data theft associated with online transactions.

### BACKGROUND

Traditionally, online payments with credit cards involve the entry of credit card data (e.g., credit card number, expiration date, security code, cardholder name, billing address, etc.) at a given web site, such as, for example, at an online or electronic commerce (e-commerce) merchant site, payment processing site (e.g., PayPal), or the like.

Known online transaction systems and methods typically involve having the user enter his or her credit card data at a website or via a mobile application, which in turn may involve transmitting the credit card data over the Internet. While there have been some improvements to securing connections between computers that send or receive sensitive information (e.g., credit card data), such information may become susceptible to interception when transmitted between nodes on the Internet. In addition, other risks associated with online transactions include keystroke logging technologies (hardware and software-based) that make it possible to track or log the keys struck on a keyboard, typically in a covert manner so that the person using the keyboard is unaware that their actions are being monitored. Accordingly, it would be desirable to allow online customers and merchants to conduct online transactions without having the customers enter and send their credit card data over the Internet.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with methods for secure payment processing. In one approach, the method may be performed by a registration server in an e-commerce network. For example, the method may involve receiving registration information from a user. The method may involve authenticating the user based at least in part on the received registration information. The method may involve gathering data regarding open credit card accounts for the user from a credit card grantor/issuer server and/or a credit bureau server. In the alternative, or in addition, gathering may involve receiving the data from the user (e.g., having the user input information regarding the open credit card accounts). In further related aspects, an electronic device may be configured to execute the methodology described above.

In accordance with one or more embodiments and corresponding disclosure thereof, various aspects are described in connection with a secure payment method operable by an authentication server in an e-commerce network. For example, the method may involve receiving log-in information for a user. The method may involve, in response to the received log-in information matching stored authentication information, accessing data regarding open credit card accounts for the user from a credit card grantor/issuer server and/or a credit bureau server. The method may involve sending secure account information about the open credit card accounts to at least one network entity (e.g., a registration server, a user device, and/or a merchant server). In related aspects, the method may further involve, in response to the user selecting a given one of the accounts from the secure account information, determining whether sufficient credit is available for the selected given account. The method may also involve, in response to verifying availability of the sufficient credit, processing a transaction with the selected given account (e.g., sending information regarding the selected given account and the transaction to a payment processing engine). In further related aspects, an electronic device may be configured to execute the methodology described above.

In accordance with one or more embodiments and corresponding disclosure thereof, various aspects are described in connection with a secure online payment method operable by an e-commerce server. For example, the method may involve receiving a first communication from at least one of a credit bureau server or a credit card grantor server, wherein the first communication contains credit card data comprising information regarding credit card accounts of a user (e.g., a credit report regarding the user or a credit card number, expiration date, security code, cardholder name, or billing address for each credit card account of the user), sending a second communication containing account information (e.g., a portion of a credit card number and information representative of a current balance associated with each credit card account) based at least in part on the credit card data to at least one network entity, receiving a third communication containing a selection of one of the credit card accounts of the user, and sending a fourth communication containing transaction information including the selected credit card account to a payment processor. The method may also involve receiving a fifth communication containing a response by the payment processor. The method may also involve receiving a fifth communication containing registration information identifying the user, performing authentication based at least in part on the registration information, and sending a sixth communication containing a request for the credit card data to at least one of the credit bureau server or the credit card grantor server. In further related aspects, the method with respect to sending the second communication may also involve displaying an interface containing one or more credit card accounts of the user based on the account information, wherein the interface is configured to allow the user to select one of the credit card accounts of the user to process a transaction.

In accordance with one or more embodiments and corresponding disclosure thereof, various aspects are described in connection with an apparatus. For example, the apparatus may have at least one processor configured to receive a first communication from at least one of a credit bureau server or a credit card grantor server, wherein the first communication contains credit card data comprising information regarding credit card accounts of a user (e.g., a credit report regarding the user or a credit card number, expiration date, security code, cardholder name, or billing address for each credit card account of the user), send a second communication containing account information (e.g., a portion of a credit card number and information representative of a current balance associated with each credit card account) based at least in part on the credit card data to at least one network entity, receive a third communication containing a selection of one of the credit card accounts of the user, and send a fourth communication containing transaction information including the selected credit card account to a payment processor. The apparatus may also have at least one processor configured to receive a fifth communication containing a response by the payment processor. The apparatus may also have at least one processor configured to receive a fifth communication containing registration information identifying the user, perform authentication based at least in part on the registration information, and send a sixth communication containing a request for the credit card data to at least one of the credit bureau server or the credit card grantor server. In further related aspects, the apparatus with respect to when it sends the second communication may also involve at least one processor configured to display an interface containing one or more credit card accounts of the user based on the account information, wherein the interface is configured to allow the user to select one of the credit card accounts of the user to process a transaction.

In accordance with one or more embodiments and corresponding disclosure thereof, various aspects are described in connection with a computer program product. For example, the computer program product may cause a computer to receive a first communication from at least one of a credit bureau server or a credit card grantor server, wherein the first communication contains credit card data comprising information regarding credit card accounts of a user (e.g., a credit report regarding the user or a credit card number, expiration date, security code, cardholder name, or billing address for each credit card account of the user), send a second communication containing account information (e.g., a portion of a credit card number and information representative of a current balance associated with each credit card account) based at least in part on the credit card data to at least one network entity, receive a third communication containing a selection of one of the credit card accounts of the user, and send a fourth communication containing transaction information including the selected credit card account to a payment processor. The computer program product may also cause a computer to receive a fifth communication containing a response by the payment processor. The computer program product may also cause a computer to receive a fifth communication containing registration information identifying the user, perform authentication based at least in part on the registration information, and send a sixth communication containing a request for the credit card data to at least one of the credit bureau server or the credit card grantor server. In further related aspects, the computer program product may cause a computer (with respect to when it sends the second communication) to display an interface containing one or more credit card accounts of the user based on the account information, wherein the interface is configured to allow the user to select one of the credit card accounts of the user to process a transaction.

In accordance with one or more embodiments and corresponding disclosure thereof, various aspects are described in connection with an apparatus. For example, the apparatus may have at least one processor configured to receive a first communication containing a request to use a payment service and send a second communication containing transaction information to a payment service, wherein the payment service in response to the second communication is configured automatically to receive a third communication from at least one of a credit bureau server or a credit card grantor server, wherein the third communication contains credit card data comprising information regarding credit card accounts of a user; send a fourth communication containing account information based at least in part on the credit card data to at least one network entity; receive a fifth communication containing a selection of one of the credit card accounts of the user; send a sixth communication containing transaction information including the selected credit card account to a payment processor; and receive a seventh communication containing a response from the payment processor. The payment service may also be configured to automatically perform further steps in response to the second communication, including to receive an eighth communication containing registration information identifying the user, perform authentication based at least in part on the registration information, and send a ninth communication containing a request for the credit card data to at least one of the credit bureau server or the credit card grantor server. In further related aspects, with respect to when it sends the fourth communication the payment service may also be configured to display an interface containing one or more credit card accounts of the user based on the account information, wherein the interface is configured to allow the user to select one of the credit card accounts of the user to process a transaction.

In accordance with one or more embodiments and corresponding disclosure thereof, various aspects are described in connection with a method of performing online sales transactions with consumers. For example, the method may involve implementing a website through which an online database of items that are selectable for sale are made available to consumers, implementing within the website a selectable check out process for paying for the items, directing consumers to an interface in which selectable credit card information (e.g., a portion of a credit card number and information representative of a current balance associated with each credit card account) communicated from at least one of a credit bureau or a credit card grantor is displayed as part of the check out process, and processing the sale of at least one of the items for one or more consumers that interacted with the interface. In various aspects, the method may use a website comprised of applets.

In accordance with one or more embodiments and corresponding disclosure thereof, various aspects are described in connection with a system of performing online sales transactions with consumers. The system may involve implementing a database of items that are selectable for sale to the consumers. The system may involve server capable of implementing a website through which the online database of items that are selectable for sale are made available to consumers, implementing within the website a selectable check out process for paying for the items, and directing consumers (e.g., by displaying a selectable link) to an interface in which selectable credit card information (e.g., a portion of a credit card number and information representative of a current balance associated with each credit card account) communicated from at least one of a credit bureau or a credit card grantor is displayed as part of the check out process. The system may involve a sales process component for processing the sale of at least one of the items for one or more consumers that interacted with the interface. In various aspects, the system may use server implementing a website comprised of applets.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a block diagram of an exemplary secure payment system.

FIG. 2A illustrates an example online merchant site.

FIG. 2B is a block diagram of one embodiment of a system for securely selecting a credit card for an online payment.

FIG. 3 provides a general flow diagram for using the system of FIG. 2B.

FIG. 4A illustrates an example sign up process for an embodiment of a secure online payment system.

FIG. 4B illustrates an example of a member sign up page.

FIG. 4C illustrates an example of an account management page.

FIG. 5A shows an example of a method for having the user sign up for a secure payment account.

FIG. 5B is an example screen shot of information displayed to a user signed in to the secure payment account.

FIG. 5C is an example screen shot of a secure payment system prompting the user to enter further details regarding card accounts.

FIG. 5D is an example screen shot of a secure payment system prompting the user to enter security information.

FIG. 5E shows an example method by which a merchant may set up a secure payment processing service.

FIG. 6A illustrates an example of how the user and the secure payment system may conduct an online transaction at a merchant's website.

FIG. 6B is an example screen shot of a secure payment member home page.

FIGS. 6C-6E are example screen shots of secure payment member pages from which the user can control cash transfers.

FIG. 7 illustrates an embodiment of a methodology operable by a registration server/device for secure online payments.

FIG. 8 shows further aspects of the methodology of FIG. 7.

FIG. 9 illustrates an embodiment of a methodology operable by an authentication server/device for secure online payments.

FIG. 10 shows further aspects of the methodology of FIG. 9.

FIG. 11 illustrates an embodiment of a methodology operable by a user device for secure online payments.

FIG. 12 shows further aspects of the methodology of FIG. 11.

FIG. 13 shows an embodiment of an apparatus for secure online payments, in accordance with the methodology of FIGS. 7-8.

FIG. 14 shows an embodiment of an apparatus for secure online payments, in accordance with the methodology of FIGS. 9-10.

FIG. 15 shows an embodiment of an apparatus for secure online payments, in accordance with the methodology of FIGS. 11-12.

FIG. 16 shows an example system for secure online payments that includes the transfer of credit card information from a credit card grantor/issuer to a credit card database/server.

FIG. 17 shows another embodiment of a methodology operable by a registration server/device for secure online payments.

FIG. 18 shows further aspects of the methodology of FIG. 17.

FIG. 19 shows another embodiment of a methodology operable by an authentication server/device for secure online payments.

FIG. 20 shows further aspects of the methodology of FIG. 19.

FIG. 21 shows another embodiment of an apparatus for secure online payments, in accordance with the methodology of FIGS. 17-18.

FIG. 22 shows another embodiment of an apparatus for secure online payments, in accordance with the methodology of FIGS. 19-20.

FIG. 23 shows another embodiment of a methodology operable by a merchant website for secure online payments.

FIG. 24 shows an example system for a merchant website providing secure online payments.

### DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

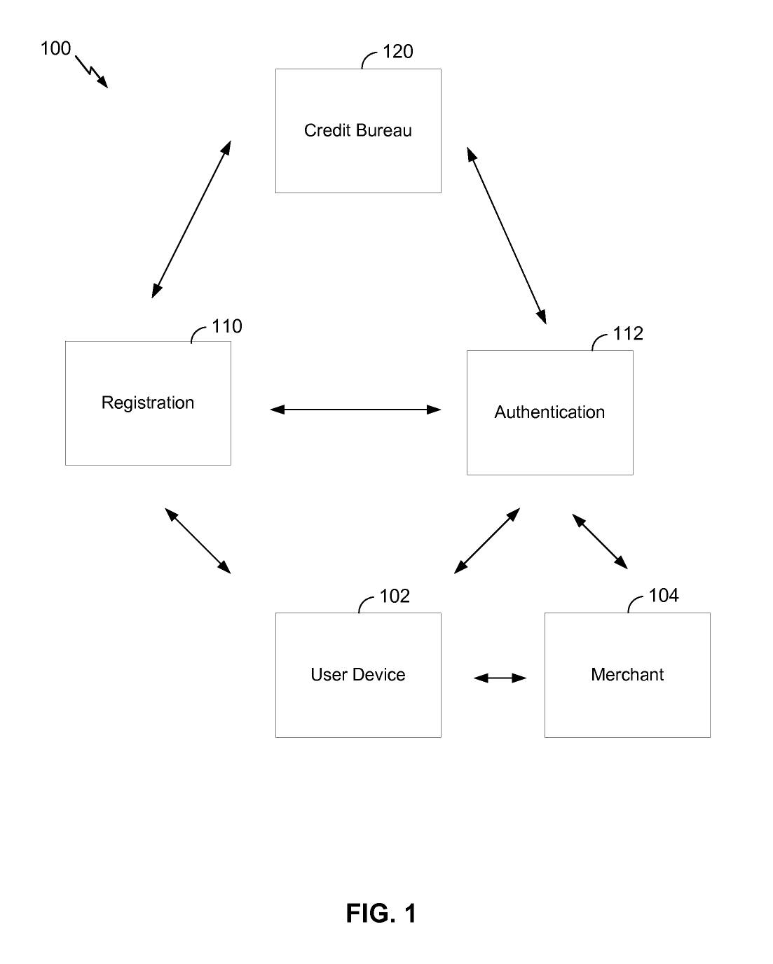

The techniques described herein may be used for or within various online or electronic commerce (e-commerce) systems, sub-systems, and/or components thereof. With reference to FIG. 1, there is shown one embodiment of a secure payment system 100 that may comprise a plurality of system entities, such as, for example, a user device 102 in operative communication with a registration server 110 and an authentication server 112. The registration server 110 and the authentication server 112 may be in operative communication with each other, and may be in operative communication with a credit bureau server 120 of a credit bureau. The system 100 may further comprise a merchant computer 104 in operative communication with the user device 102 and the authentication server 112. For example, the credit bureau may be a credit card processor that submits the charge on behalf of the merchant. In another example, the credit bureau may be a credit card processor that provides the functionality to a processor. In both examples, the charge may be credited to the merchant.

It is noted that, in other embodiments, some of the system entities may not be in operative communication with each other. It is further noted that, in other embodiments, one or more of the system entities may be combined or may be part of another system entity. For example, the registration server 110 and the authentication server 112 may be combined into a single system entity.

In related aspects, one or more of the system entities may comprise a computing device, server, wired or wireless communication device, or any other machine/device capable of communication with a computer network. In further related aspects, one or more of the system entities may communicate with each other a communication network, such as the Internet, preferably via secured connections or links.

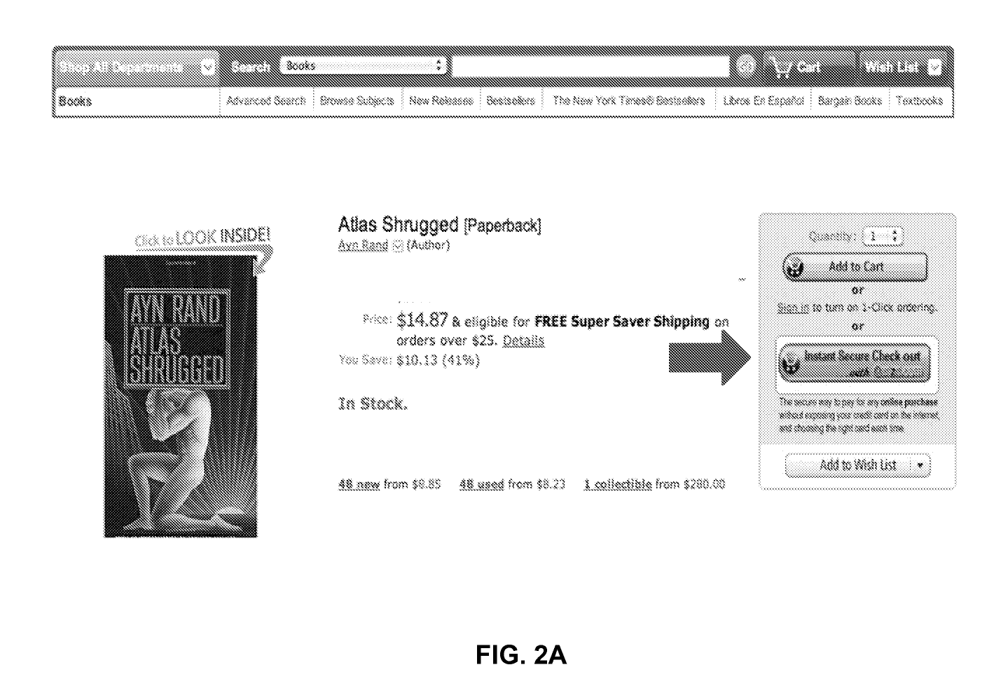

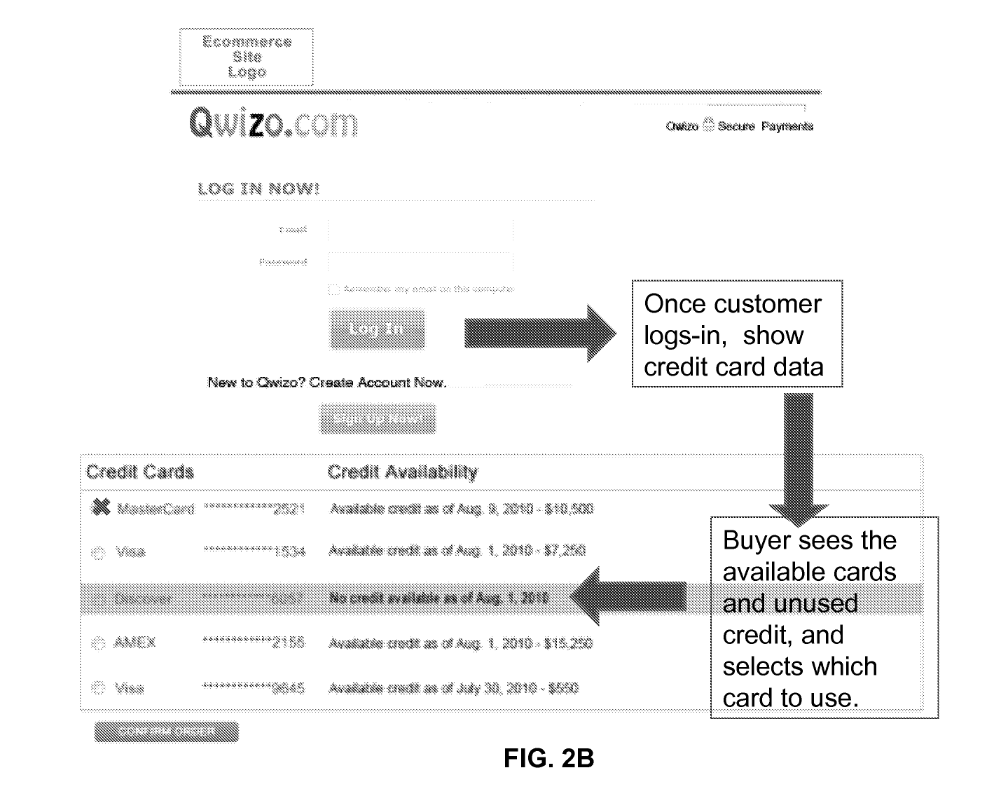

Referring to FIG. 2A, an exemplary online merchant site is shown. The online merchant site (e.g., Amazon.com or eBay.com) typically includes a checkout button or link to a payment processing site, which may or may not be affiliated with the merchant site. In the embodiments shown herein, the checkout button is for a secure payment system/service referred to as Qwizo.com.

With reference to FIG. 2B, there is shown one embodiment of a system for allowing a user to securely select a credit card from a list for an online payment. The user may be presented with a login page or site that includes fields for the user to enter a user identification (e.g., email address) and password. Once the user enters the requisite information and logs-in, credit card data may be displayed to user. The buyer sees the available credits card(s), and if more than one is listed, selects which card to use. Information regarding each card, such as, for example, availability data, unused credit, card status, or the like, may also be displayed to the user, thereby allowing the user to make an informed decision about which card to use. Such information may also keep the user informed of lost or stolen credit cards, as unusual changes to the availability data would be reflected in the credit card data.

In related aspects, the credit card data displayed to the user may be in the form of secure account information. The secure account information may be based on or include parts of data regarding open credit card accounts from a credit card report for the user. The data may be pulled from or accessed at a credit bureau server or the like. For example, the secure account information may be a subset of the pulled data. The subset of the pulled data may be truncated versions of credit card numbers. The truncated versions may be the last four digits of the credit card numbers or the like.

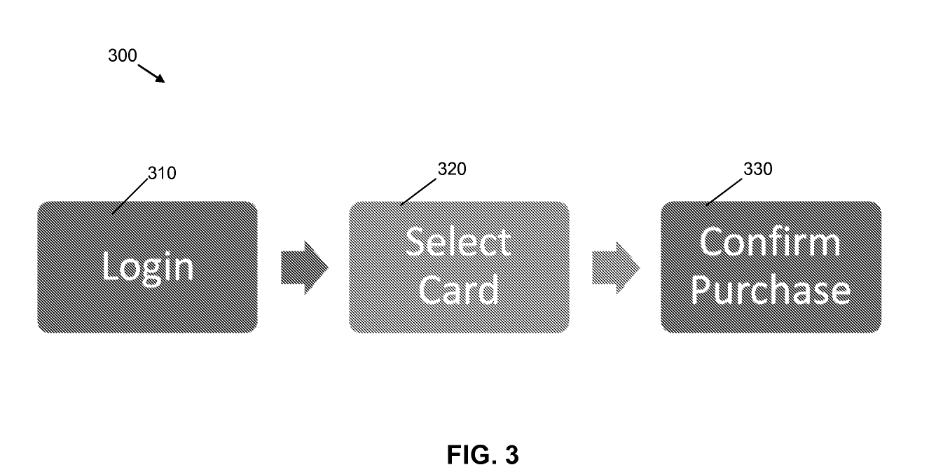

With reference to FIG. 3, there is shown a summary of online purchasing process 300 according to the secure payment service described herein. Described generally, the process 300 may involve, at 310, having the user or customer log-in to his/her account on the secure payment system. The process 300 may involve, at 320, allowing the user to select a credit card to use, which in turn may involve pulling credit card data from a credit bureau site and displaying the credit card data to the user may as secure account information, as described above. The process 300 may involve, at 330, allowing the user to confirm the purchase.

In related aspects, the techniques of process 300 may be used on any e-commerce website. The user may select the present secured transaction service, as they would with PayPal or a credit card. However, no credit card data entry by the user is required, thereby preventing the transmission of user-entered credit card data across the Internet.

In further related aspects, the techniques of the secure payment service described herein gives customers a safe and secure way to make online purchases. The techniques described herein allow customers to make purchases online using credit card information from their credit report. The techniques described herein allow customers to monitor their credit card data and stay informed regarding changes to their credit availability.

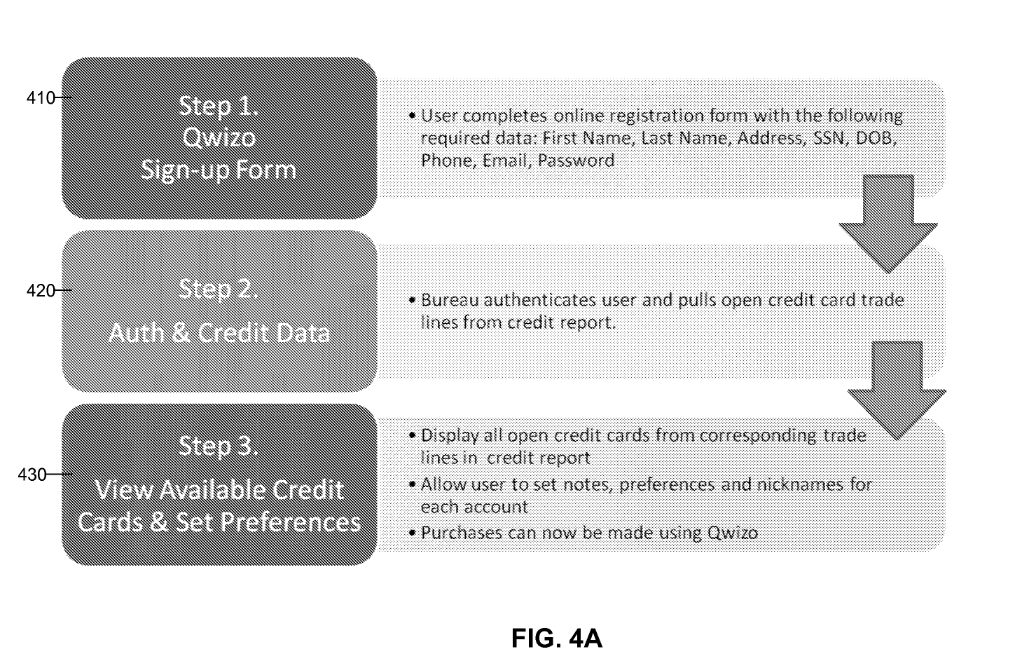

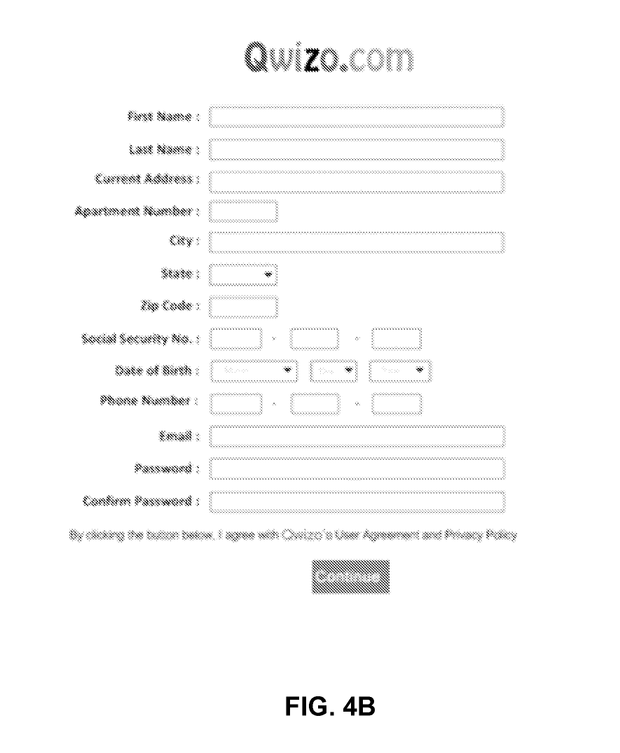

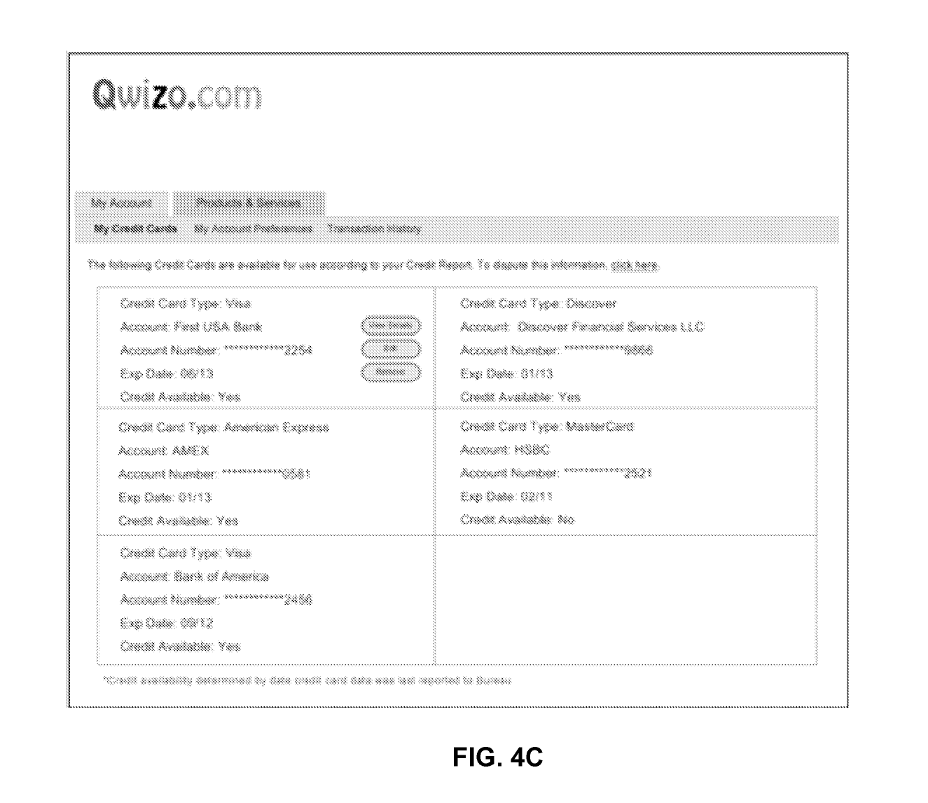

With reference to FIG. 4A, there is shown a summary of an embodiment of a sign up process 400 for the secure payment service. The process 400 may involve, at 410, providing the user with a sign up form. The user may complete an online registration form with data, such as, for example, first name, last name, address, social security number, date of birth, phone numbers, email address, password, etc. An example of a member sign up form or page is shown in FIG. 4B.

With continued reference to FIG. 4A, the process 400 may involve, at 420, authenticating the user and communicating with a credit bureau or the like to obtain credit data for the user. The credit bureau may authenticate the user and may pull open credit card trade lines from a credit report or the like. At 430, the process 400 may involve allowing the user to view available credit cards and optionally set preferences. For example, the secure payment system may display open credit cards from corresponding trade lines in the credit report. The system may allow the user to set notes, preferences, and/or nicknames for each account. Purchases can then be made using the secure payment service.

In related aspects, an account management page may be displayed to the user to allow the user to view available credit cards and/or set preferences. An example account management page is shown in FIG. 4C.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

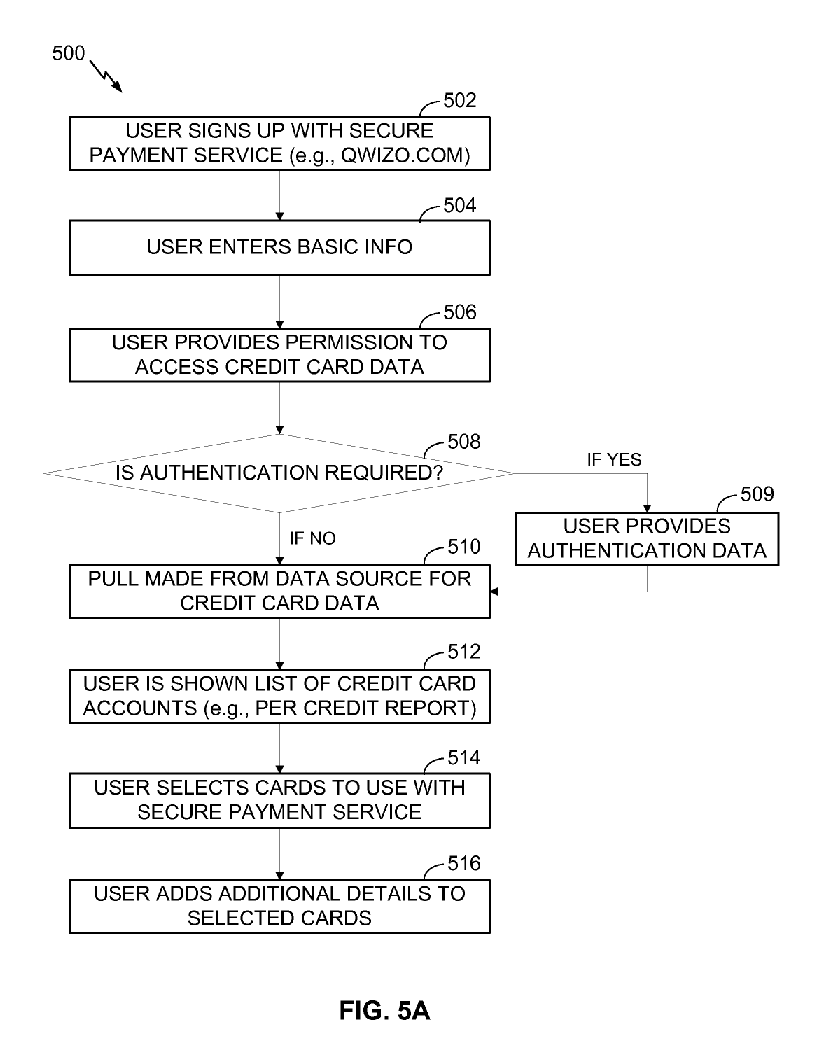

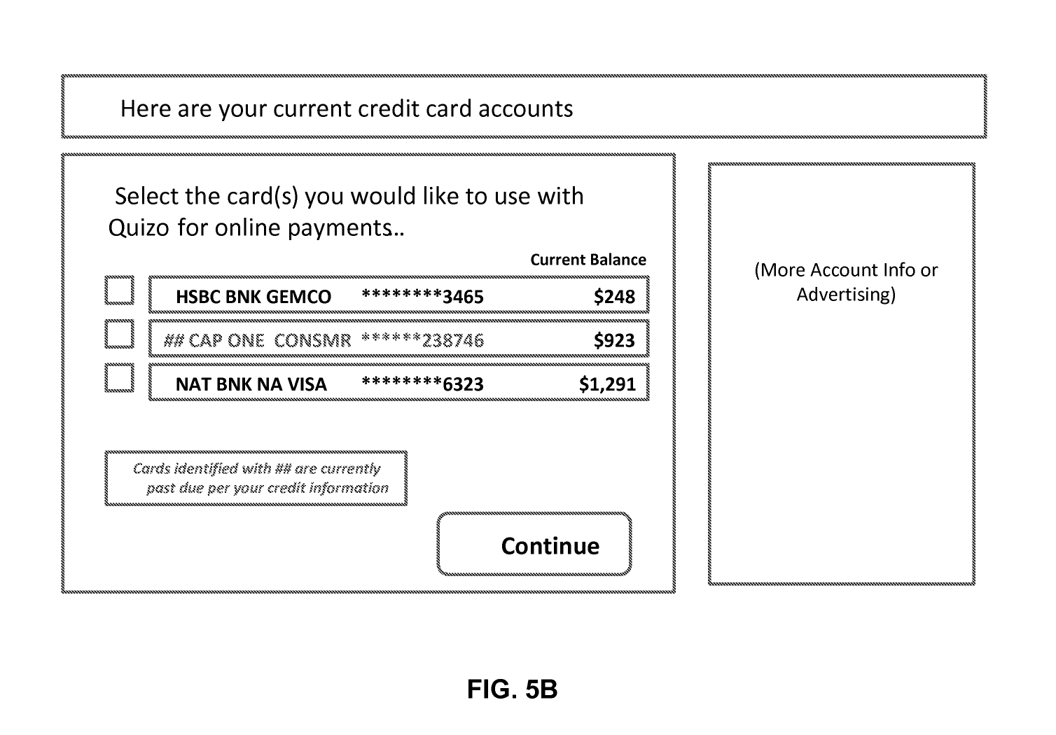

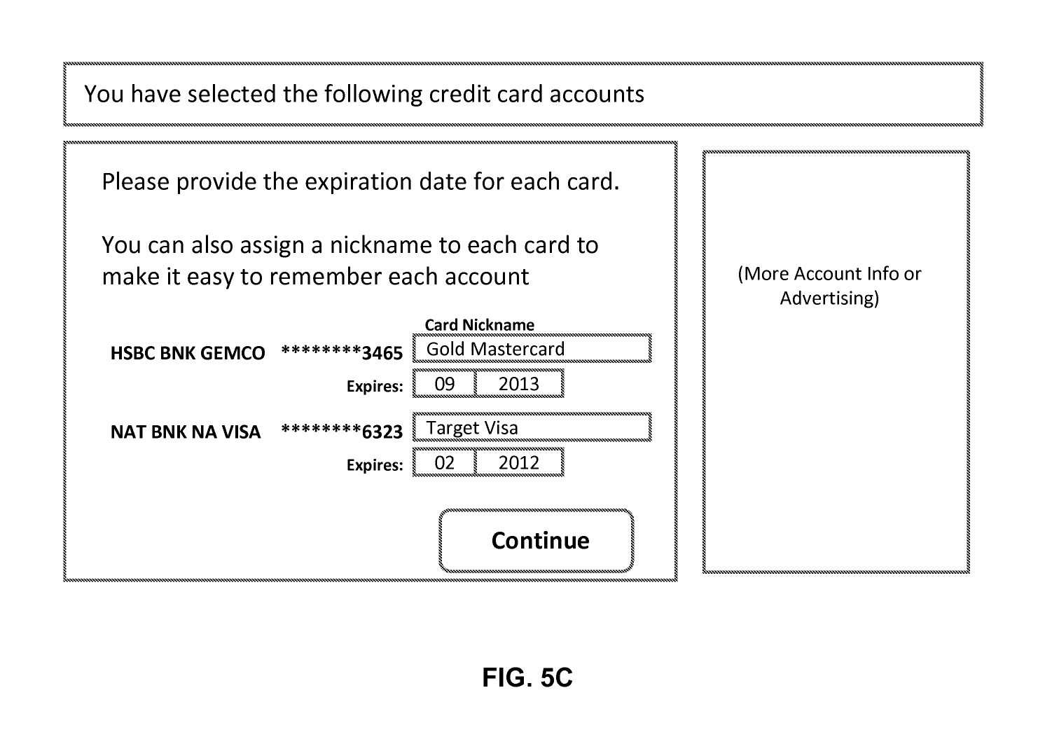

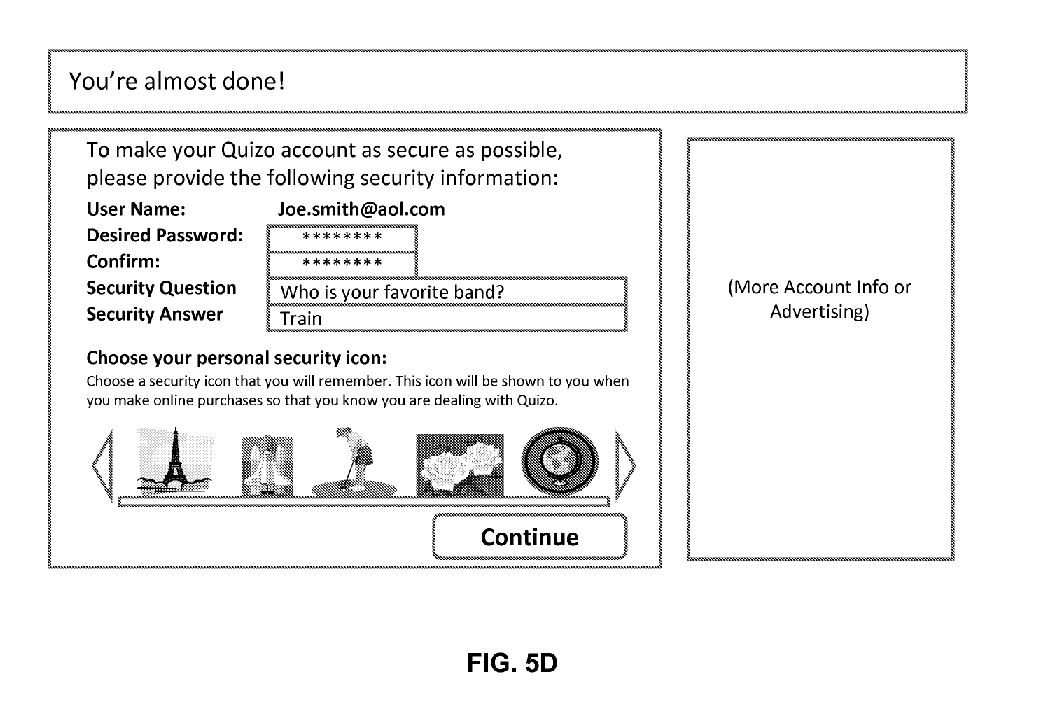

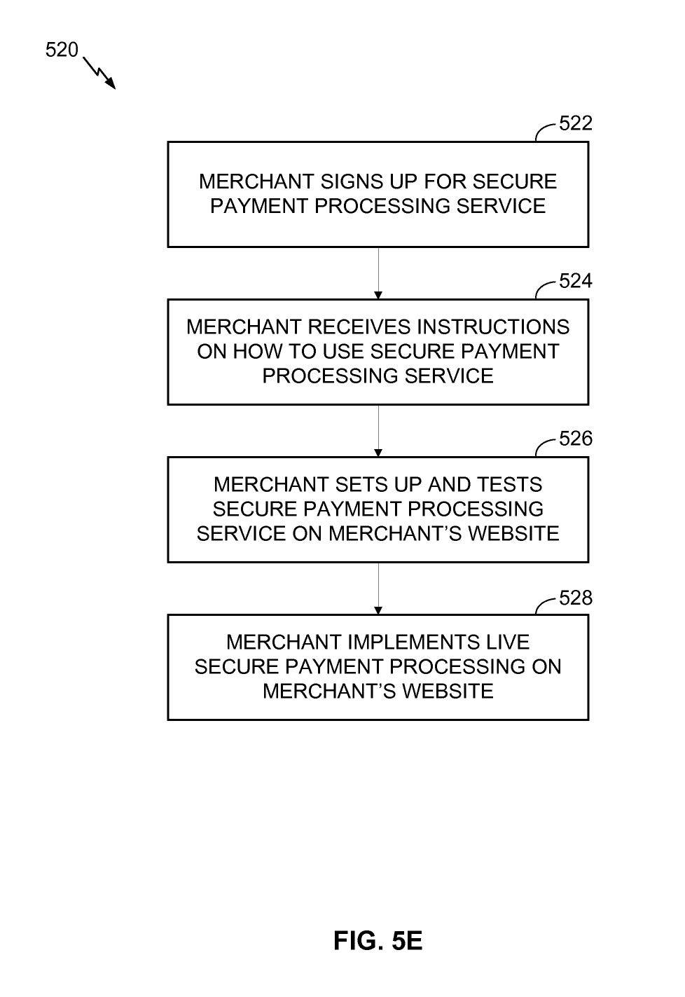

In accordance with one or more aspects of the embodiments described herein, the secure payment techniques described herein involve (a) having the user sign up a secure payment account, (b) having the merchant set up to the secure payment processing service, and (c) having the user select and use the secure payment service on the merchant's website. With reference to FIG. 5A, there is shown an embodiment of a methodology 500 for having the user sign up a secure payment account. At 502, the user may select to sign up for the secure payment service. At 504, the user may enter basic information, such as, for example, name, address, email, phone, social security number or other unique identifier, date of birth, security information (e.g., user name, password, selected security icon, etc.). It is noted that the secure payment system or a given component thereof may verify the user provided information (e.g., email address), such as by clicking on a link in a confirmatory email, Short Message Service (SMS) message, or the like. At 506, the user may provide permission to access or pull data regarding open credit card accounts (e.g., from a credit report), and/or may provide such data regarding open credit card accounts.

For example, if the user provides permission to pull data regarding open credit card accounts, the method 500 involves, at 508, having the secure payment system determine whether authentication is required. If so, at 509, the requisite authentication data may be provided by the user and, at 510, a pull is made from a data source for credit card data (e.g., a credit bureau or credit information entity/group), wherein the credit card data may include card names, card numbers (e.g., masked), account statuses (e.g., open, closed, over the limit, past due, collection, etc.), current balances, current payment amounts, etc. If not, the pull may be made from the data source without authentication. In related aspects, the secure payment system may assign a unique PIN to each card account pulled from the data source. In further related aspects, the user may provide credit card data to be used in conjunction with, or in lieu of, the pulled credit card data.

At 512, the user may be shown a list of credit card accounts according to the information or report pulled from the data source. In related aspects, the user may be shown balances on his/her cards (e.g., per latest balance reported on the pulled data, such as a credit report or the like) at the time of the online transaction at the merchant's website. An example of the information displayed to the user is illustrated in the embodiment of FIG. 5B.

With reference once again to FIG. 5A, at 514, the user may select which card accounts to use with the secure payment service (i.e., the user may select one of his/her card accounts authorized by the secure payment system). For example, closed or collection accounts may be excluded from use with the secure payment service. In addition, or in the alternative, accounts not shown on the pulled report may be excluded. At 516, the user may add further details regarding selected cards accounts, such as, for example, a cross-reference identifier (e.g., an Experian ID for a given account), a card nickname, an expiration date, permission for other secure payment service users to transfer cash to a given card, etc. The secure payment system may prompt the user to enter further details regarding the selected card accounts, as shown in FIG. 5C. The secure payment system may also prompt the user to enter provide security information (e.g., password, security question, and security answer), and/or to select a security icon that is displayed to the user when making online purchases (so that the user knows that he/she is interfacing with the secure payment system, rather than a fraudulent or phishing website that is trying to pass itself off as the secure payment system), as shown in FIG. 5D. In another embodiment, details (e.g., expiration dates) regarding the selected card accounts may be obtained or received from a third-party entity/source, so that the user does not have to add/update them. For example, the expiration date and/or other details for one or more of the card accounts may be automatically updated by the third-party entity. This would add an additional layer of security since the user would enter little to no card information when setting up the secure payment account and/or when using the secure payment account for an online transaction.

In related aspects, credit card information may be obtained from a credit card company (i.e., credit card grantor or issuer), in addition to, or in lieu of such credit card information obtained from a credit bureau. Examples of information obtained from a credit card grantor may include credit card balances with the last balance date, current card status data, credit card numbers (e.g., unscrambled, un-truncated, or otherwise complete credit card numbers when such credit card numbers are not available from the credit bureau. Information obtained from the credit card grantor may be combined with other information obtained regarding the user and his/her credit card accounts. Credit card information obtained or received from the credit card grantor and/or the credit bureau may be saved into a proprietary database or server.

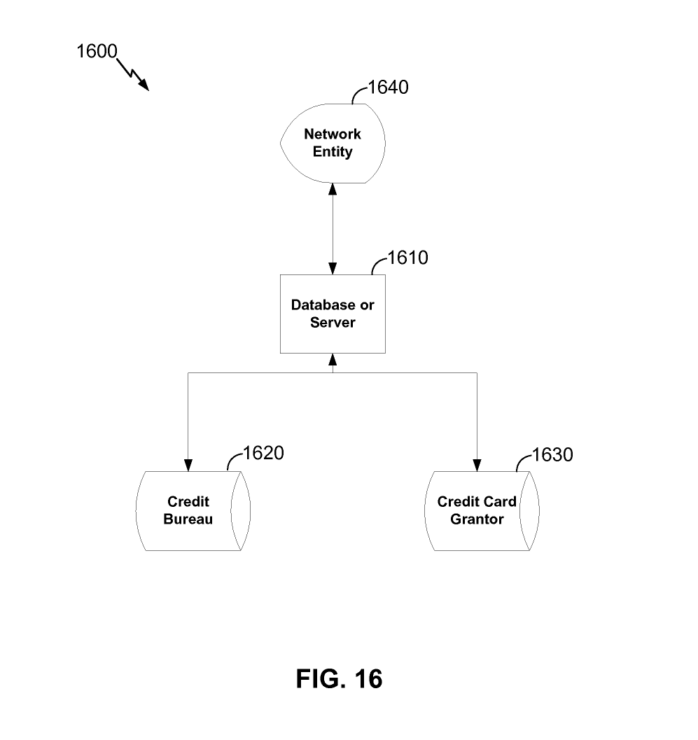

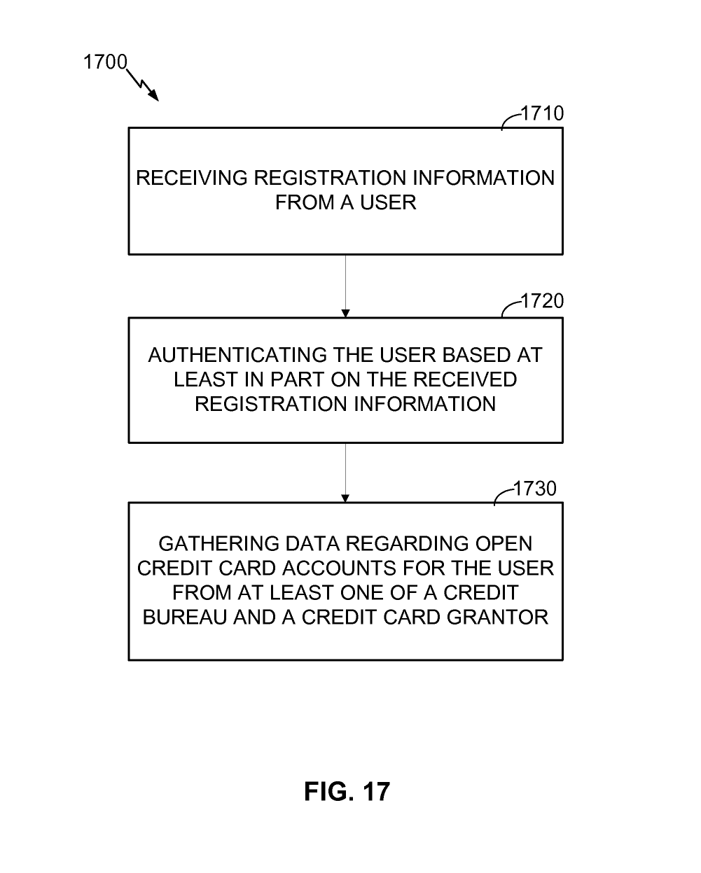

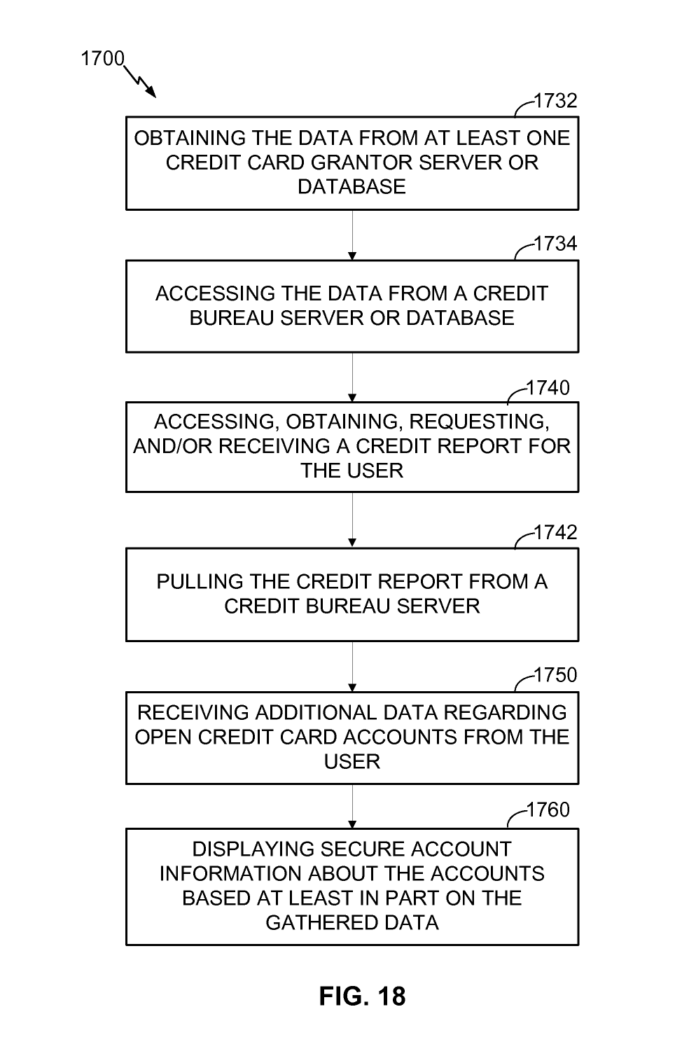

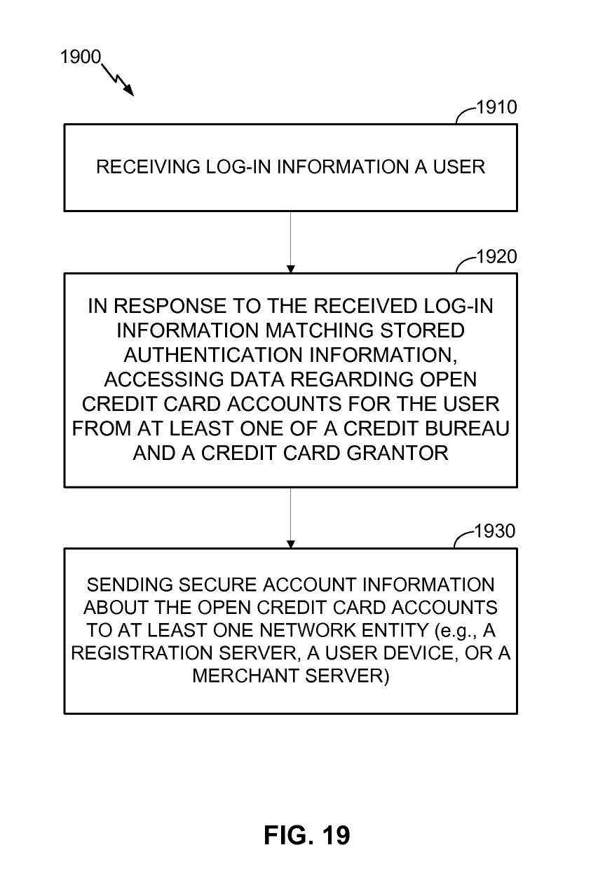

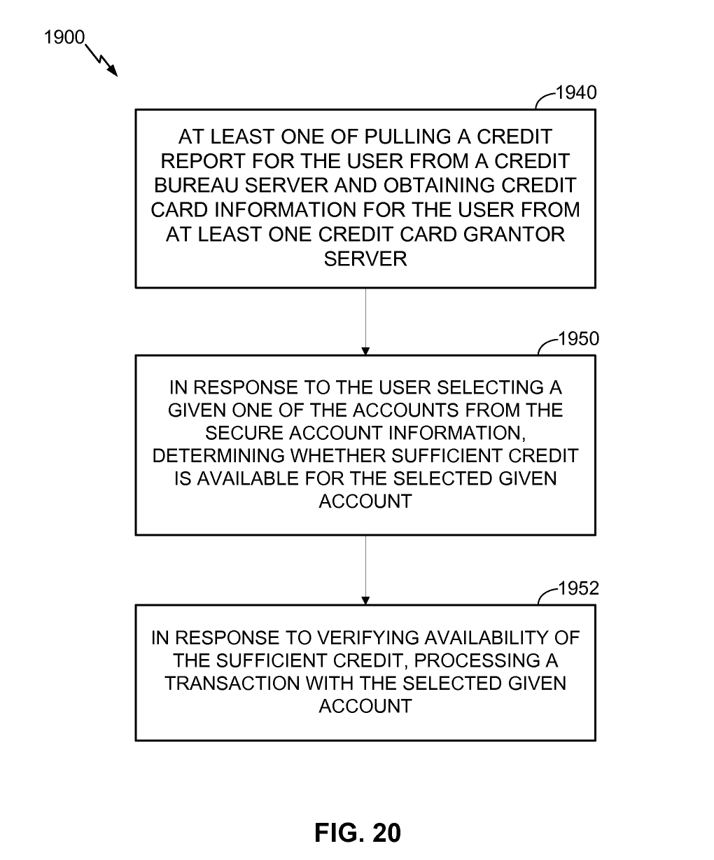

With reference to FIG. 16, in one embodiment, there is provided a system 1600 that includes a credit card database or server 1610 that is in operative communication with a credit card grantor server 1630 or the like. The server 1610 may also be in operative communication with a credit bureau server 1620 or the like. The server 1610 may be in operative communication with another network entity 1640, which may be, for example, a registration server, an authentication server, or the like. For example, FIGS. 17-18 show an example embodiment of a method 1700 performed by a registration server or the like, as explained in further detail below. In another example, FIGS. 19-20 shown an example embodiment of a method 1900 performed by an authentication server or the like, as explained in further detail below.

In further related aspects, the user may select notification preferences about his/her secure payment account and/or associated credit card accounts. In yet further related aspects, the online transactions are not limited to the purchase of goods or services on the merchant's site. For example, the online transactions may generally involve cash transfers (e.g., at an online auction site) that may include incoming cash to the user's secure payment account or outbound cash to other secure payment accounts. The user may decide which other users have access to given ones of his/her card accounts (e.g., for inbound cash transfers or purchases).

In still further related aspects, the credit card data/information regarding user(s) may be updated on an off-line basis, such as, for example, via a batch process with the credit bureau(s) and/or the credit card grantor(s) and/or the like. In one scenario, a secure online payment/purchase service provider may own and/or manage a credit card information database or server (e.g., the database/server 1610). The service provider, or affiliates thereof, may send a file/list of a given group of users to the credit bureau(s) and/or credit card grantor(s) to obtain a batch response regarding the users in the given group from the credit bureau(s) and/or the credit card grantor(s). In related aspects, the users in the given group may have common characteristic(s) or fall under one or more defined categories (e.g., active credit card users, active online purchasers, users who made a defined number of purchases within a defined time period, other behavioral data, users who routinely purchase particular types of products or services, users who have a particular type of credit card, users who have a particular type of credit rating/score, etc.).

In further related aspects, the batch response from the credit bureau(s), credit card grantor(s), and/or the like, may include updated and/or supplemental data regarding the open credit card accounts of the users (e.g., credit card status data). The service provider may process the received updated/supplemental data and update the credit card data stored in the credit card information database/server. In yet further related aspects, the credit card database/server may be configured to automatically request and/or obtain the updated/supplemental data from the credit card bureau(s) credit card grantor(s) and/or the like, such as, for example, on a periodic basis (e.g., weekly) and/or in response to a defined triggering event. In still further related aspects, the credit card database/server may obtain the updated/supplemental data from a plurality of other servers owned, managed, or otherwise affiliated with the credit bureau(s) and/or the credit card grantor(s) and/or the like.

With reference to FIG. 5E, there is shown an embodiment of a methodology 520 for having the merchant set up a secure payment processing service. At 522, the merchant may initiate signing up for the service. At 524, the merchant may receive instructions on how to implement and use the service on the merchant's website. At 526, the merchant may incorporate and test the service on the merchant's website according to the received instructions. At 528, the merchant may implement live secure payment processing according to the service. The merchant's benefits may include, but are not limited to, a secure payment processing service that works with different payment processors to provide multiple sources of payment, and the fact that there is no storing of credit card information by the merchant.

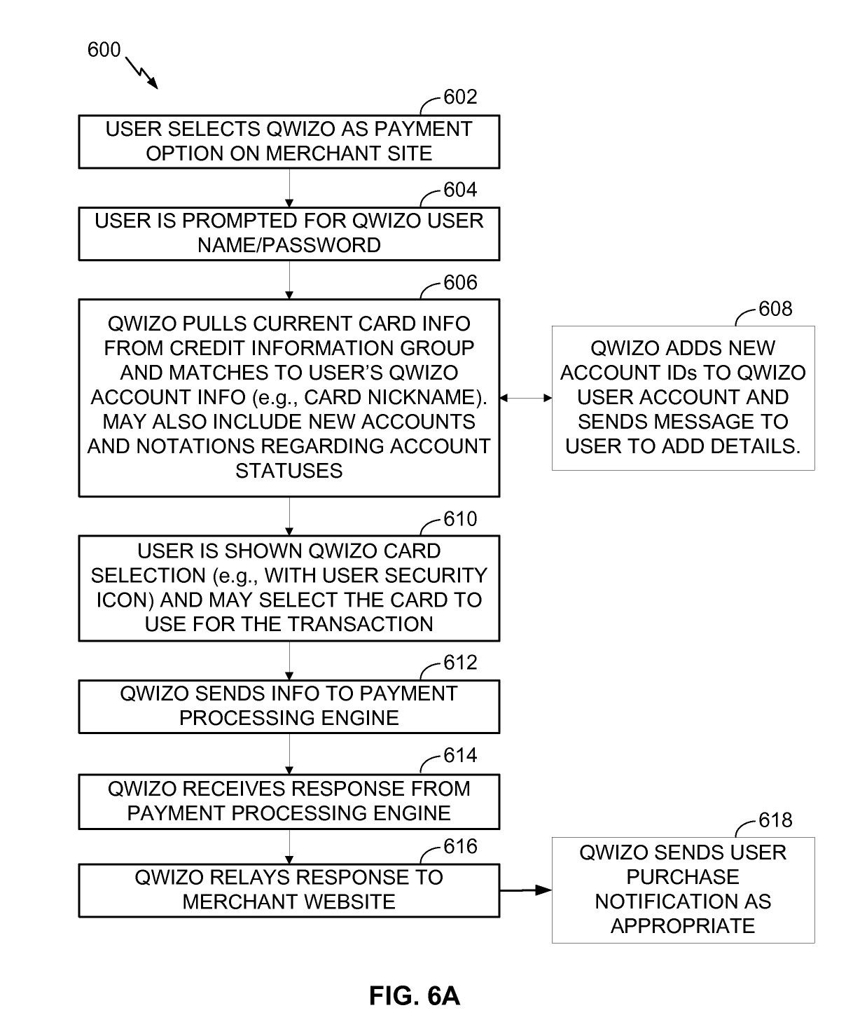

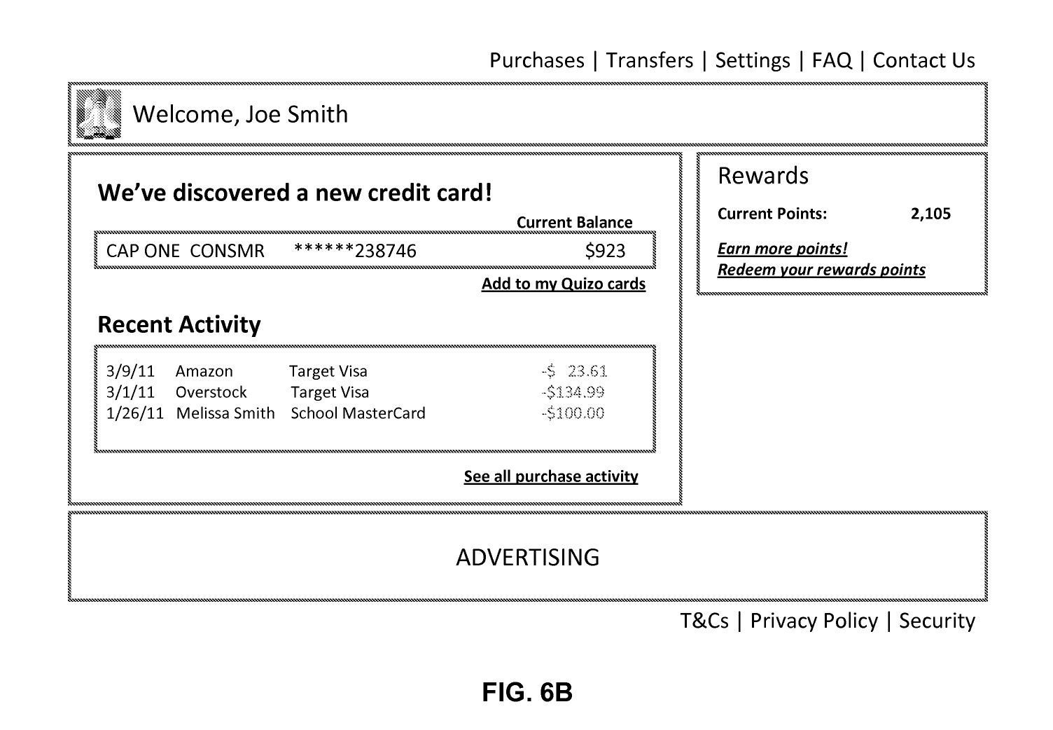

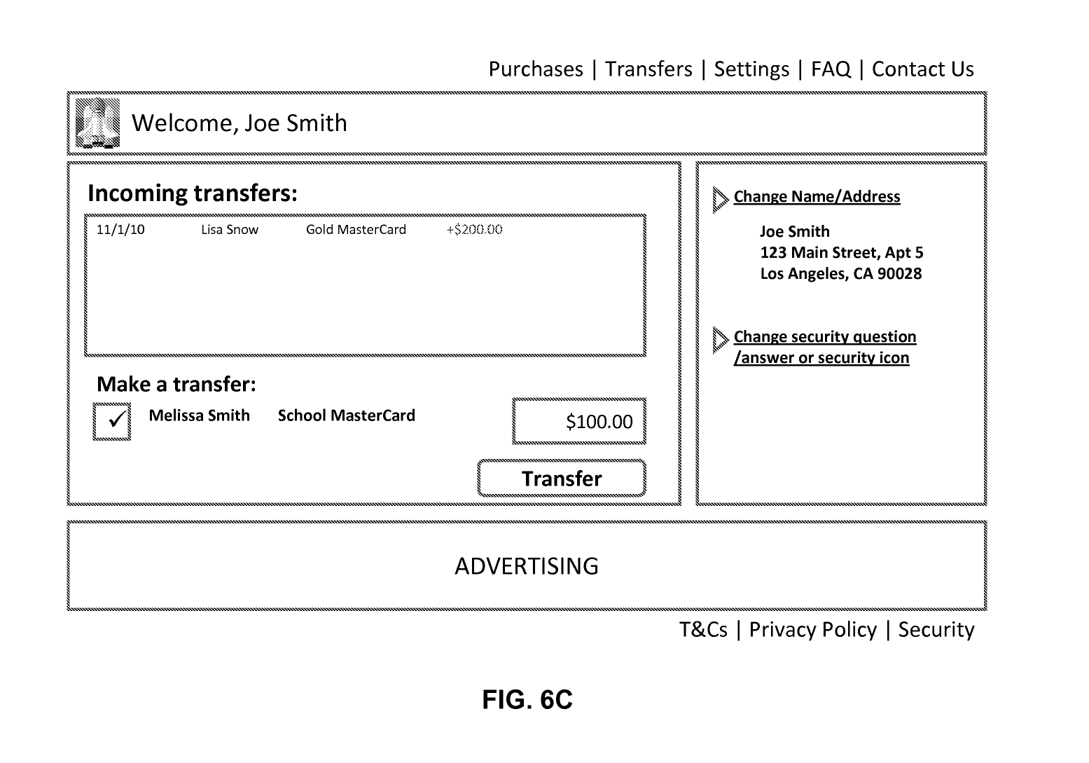

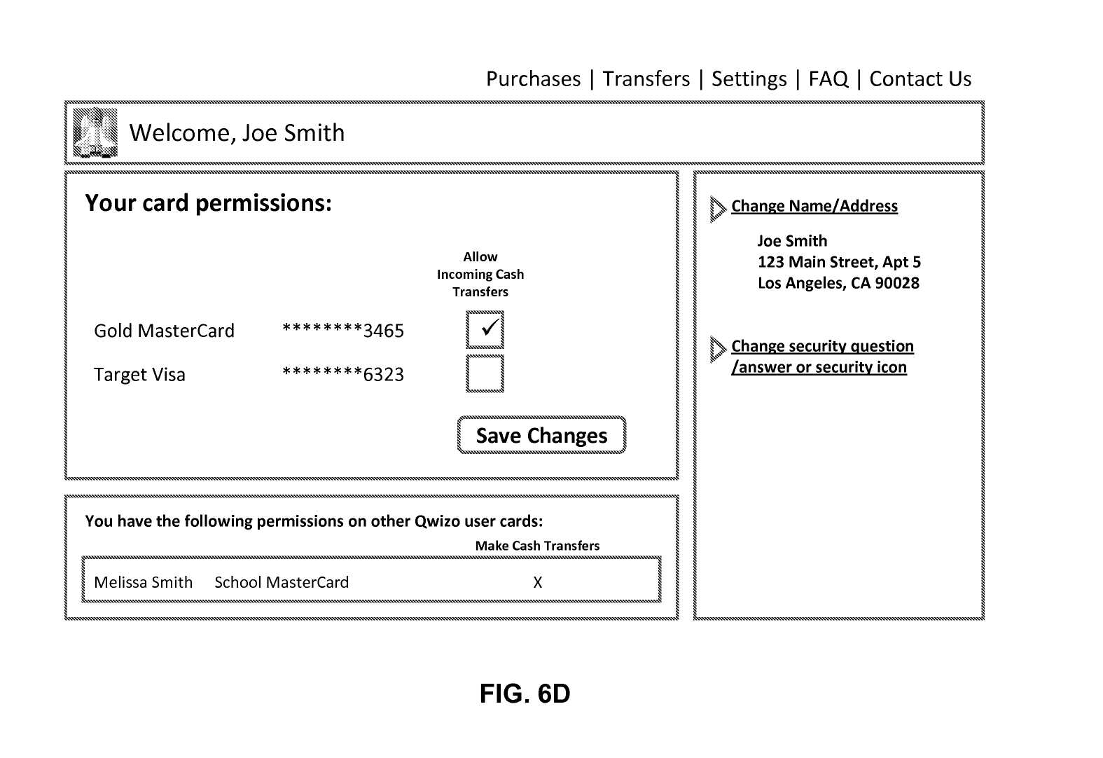

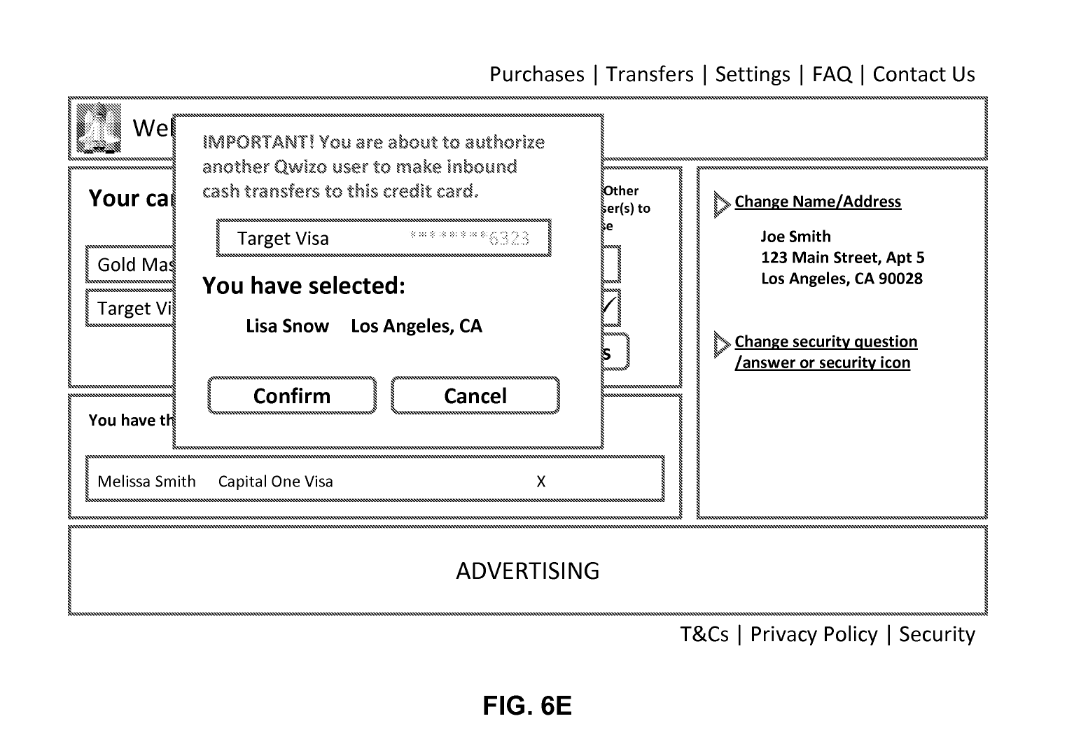

With reference to FIG. 6A, there is shown an embodiment of a methodology 600 for having the user select and use the secure payment service on the merchant's website, assuming that the user has already signed up for a secure payment account and that the merchant has set up the secure payment service on the merchant's website(s). At 602, the user may select the secure payment service option (e.g., “Qwizo”) on a merchant's website. At 604, the user may be prompted for a user name or ID and password. It is noted that the merchant may transmit the user's basic information (e.g., email address) to the secure payment system/service so that the system can show a security icon for security purposes. It is further noted that a device identifier for the user's device (e.g., mobile device, laptop, etc.) may be used in conjunction with the user ID and password to authenticate the user.

At 606, in response to the user being found or authenticated, the secure payment system may obtain the current credit card information for the user and update the user's secure payment account. For example, the secure payment system may pull the current credit card information from a credit bureau or credit information entity (e.g., Experian), and match the pulled information to the user's secure payment account (e.g., card nickname, expiration date, etc.). The secure payment system may add new card accounts and/or notations regarding the status of the user's card accounts tied to the user's secure payment account. In one embodiment, the secure payment system may display a secure payment member home page to the user, as shown in the example screen shot of FIG. 6B. As shown, the secure payment member home page may include a notification regarding a new card account (obtained in block 606) that the user may add to the list of cards authorized for use with the secure payment system. The secure payment member home page may include a summary of recent activity, as well as the option of seeing more or all purchase/transactions activity. In related aspects, the secure payment system may provide an incentive for customers to use its secure payment service by awarding frequent user points or awards. If there is a rewards/points program or promotion associated with the user's secure payment account, the secure payment member home page may display information regarding the user's current points or a link to such information. In addition, advertising may be displayed on the secure payment member home page.

With reference once again to FIG. 6A, at 608, the secure payment system may optionally add new account IDs to the user's secure payment account and send emails or SMS messages to the user asking him/her to verify the new card accounts and/or add further details regarding the new card accounts. A unique PIN may be assigned to each card account for communication with the credit bureau. In related aspects, a notice may be sent to the user when a new card account is detected at block 606. The user may be directed to a secure payment site to login and add details for the newly detected card account. If the new card account is selected for use during the transaction, the secure payment system may save pertinent details (e.g., expiration date) entered by the user at the time of the transaction. In further related aspects, the expiration date and/or other pertinent detail(s) may be obtained or received from a third-party entity's server or the like, so that the user does not have to enter them.

At 610, the user may be shown a list of card accounts associated with his/her secure payment account, and the user may select the card to use for the transaction. At 612, the secure payment system may send the transaction information to a payment processing engine associated with the selected card. For example, the transaction information may include details regarding the purchase date/time, the merchant, the amount, a transaction identifier or ID, and the card account (e.g., the nickname of the card account selected for the transaction). At 614, the secure payment system may receive a response from the payment processing engine. At 616, the secure payment system may relay the response to the merchant's website. The response may include or be appended with a identifier for the user-selected card account such that the merchant may initiate credits/refunds without the user having to sign in. At 618, the secure payment system may notify the user (e.g., via email, SMS messaging, and/or phone call) regarding the purchase as appropriate. The notification may include the transaction information and a request to contact the secure payment system immediately if the user did not authorize the transaction. The notification to the user may include information regarding purchases, card expirations, newly opened card accounts, card accounts being closed or past due or in collection, and card balances or over the limit warnings. The notification may indicate changes to the user's secure payment account generally, such as, for example, that permission has been granted, changed, or revoked for purchase rights. The notification may indicate that purchase limit has been reached for using ones of the card accounts for the secure payment account. The notification may relate to an upcoming expiration date for a given card account, and may include a request to update card account information (e.g., a new expiration date).

As mentioned previously, involvement of the secure payment system in online transactions is not limited to the purchase of good or services at a merchant's website. As shown in FIG. 6C, the user may configure and use his/her secure payment account for transfers of cash or credit to/from other secure payment account users. For example, the secure payment system may provide a page to the user that includes a field summarizing incoming transfers (e.g., $200 to the user's Gold MasterCard from Lisa Snow), as well as a separate field that allows the user to make an outgoing transfer (e.g., $100 to Melissa Smith's School MasterCard). With reference to the screen shot of FIG. 6D, the user may modify which of his/her cards may receive incoming cash transfers. For example, the user may permit additional cards (e.g., Target Visa) to receive incoming cash transfers from other authorized users (e.g., Lisa Snow in Los Angeles, Calif.) of the secure payment system, as shown in the screen shot of FIG. 6E. In related aspects, a notification (e.g., via email, SMS message, or phone call) may be sent to the user regarding incoming transfers (e.g., “A cash transfer has been received on your secure payment account”), wherein the notification may include details regarding the transfer date/time, who made the transfer, card nickname or identifier, amount, or the like. Similarly, a notification may be sent to the user regarding outgoing transfers (e.g., “A case transfer had been made from your secure payment account”), wherein the notification may include details regarding the transfer date/time, who the transfer is being made to, card nickname or identifier, amount, etc. The notification for outgoing transfers may also include instructions to contact the secure payment system immediately if the user did not authorize the outgoing transfer.

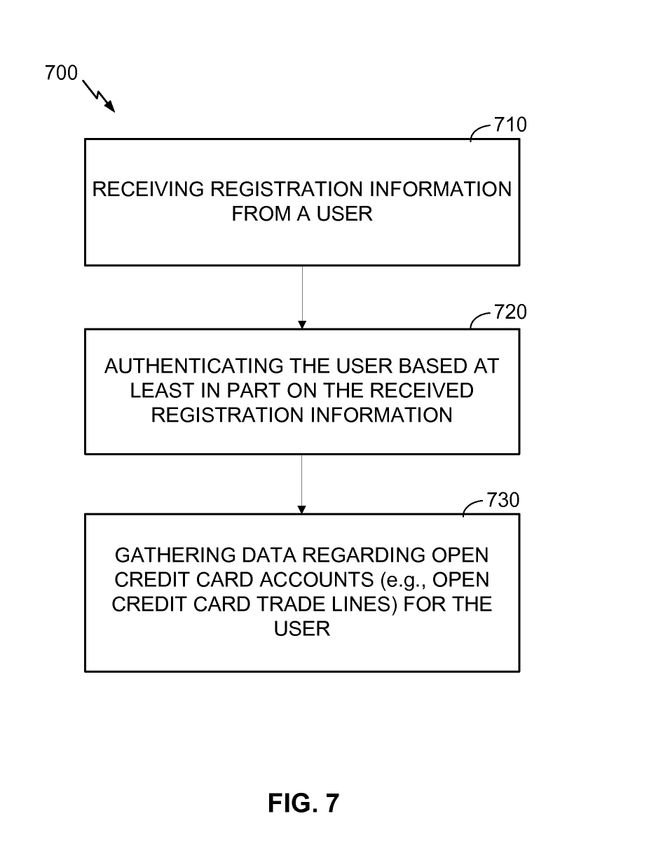

In accordance with one or more aspects of the subject of this disclosure, there is provided a method for secure online payments. With reference to FIG. 7, illustrated is a methodology 700 that may be performed at a registration server or the like in an e-commerce network. The method 700 may involve, at 710, receiving registration information from a user. The method 700 may involve, at 720, authenticating the user based at least in part on the received registration information. The method 700 may involve, at 730, gathering data regarding open credit card accounts (e.g., open credit card trade lines) for the user.

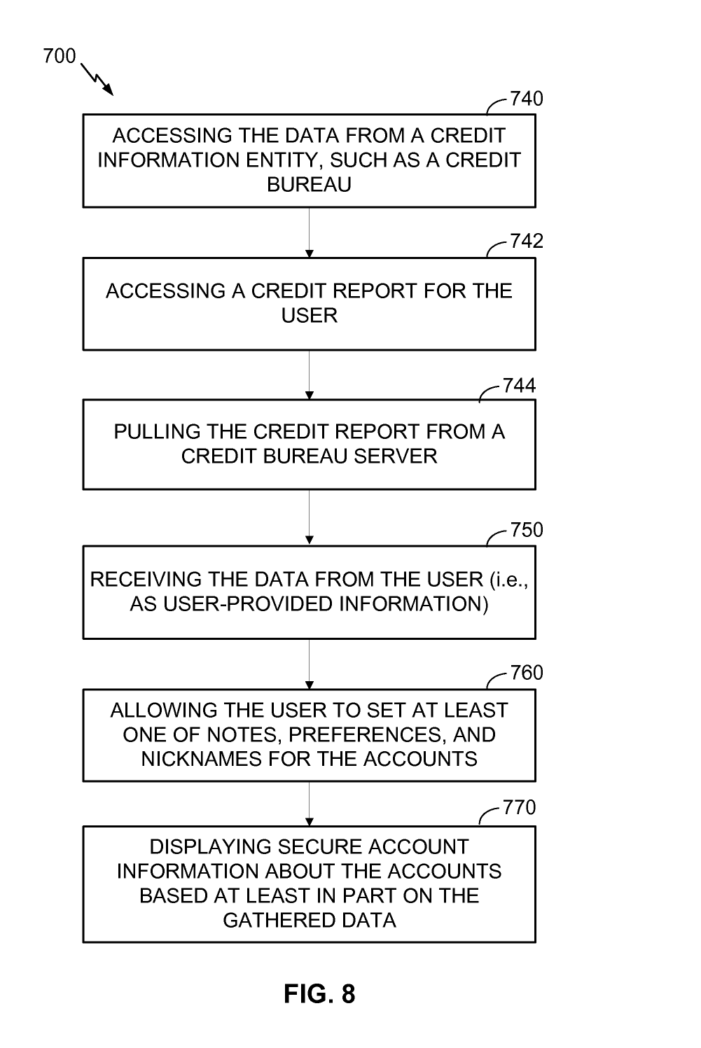

With reference to FIG. 8, gathering may further involve, at 740, accessing the data from a credit information entity, such as a credit bureau. Gathering may further involve, at 742, accessing a credit report for the user. Accessing the credit report may involve, at 744, pulling the credit report from a credit bureau server. In the alternative, or in addition, gathering may further involve, at 750, receiving the data from the user (i.e., as user-provided information). The method 700 may involve, at 760, allowing the user to set at least one of notes, preferences, and nicknames for the accounts. The method 700 may involve, at 770, displaying secure account information (e.g., a subset of the gathered data and/or truncated versions of credit card numbers for the accounts) about the accounts based at least in part on the gathered data.

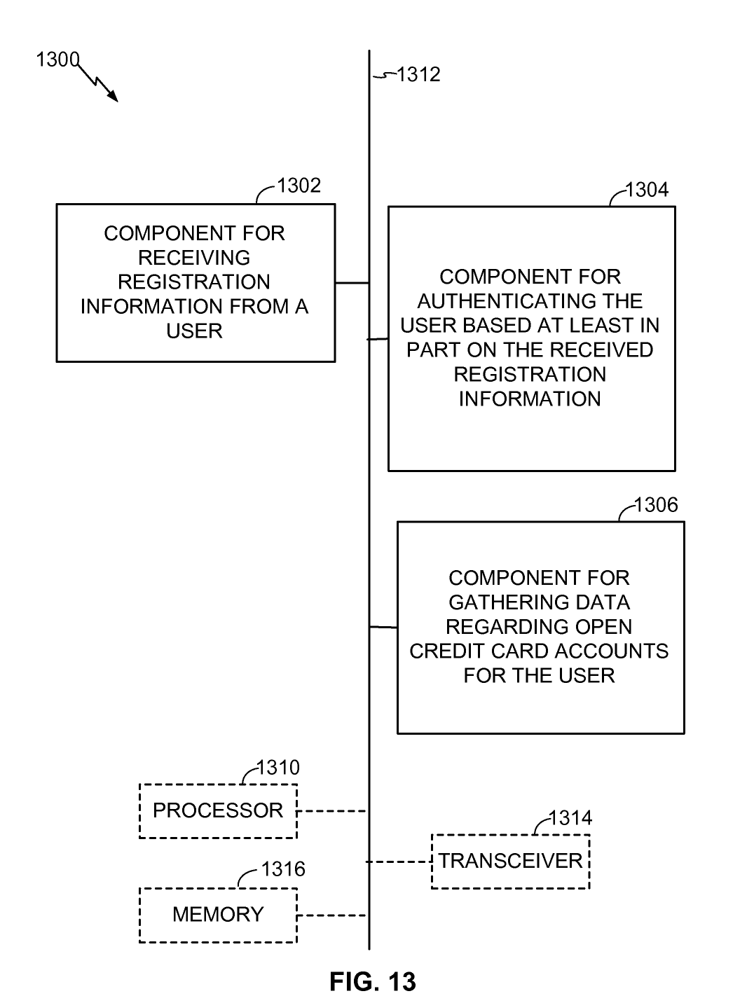

In accordance with one or more aspects of the embodiments described herein, there are provided devices and apparatuses secure online payments, as described above with reference to FIGS. 7-8. With reference to FIG. 13, there is provided an exemplary apparatus 1300 that may be configured as a registration server, or as a processor or similar device for use within the registration server. The apparatus 1300 may include functional blocks that can represent functions implemented by a processor, software, or combination thereof (e.g., firmware).

For example, the apparatus 1300 of FIG. 13 may comprise an electrical component or module 1302 for receiving registration information from a user. The apparatus 1300 may comprise an electrical component 1304 for authenticating the user based at least in part on the received registration information. The apparatus 1300 may comprise an electrical component 1306 for gathering data regarding open credit card accounts for the user.

In related aspects, the apparatus 1300 may optionally include a processor component 1310 having at least one processor, in the case of the apparatus 1300 configured as a network entity, rather than as a processor. The processor 1310, in such case, may be in operative communication with the components 1302-1306 via a bus 1312 or similar communication coupling. The processor 1310 may effect initiation and scheduling of the processes or functions performed by electrical components 1302-1306.

In further related aspects, the apparatus 1300 may include a communication or transceiver component 1314. A stand alone receiver and/or stand alone transmitter may be used in lieu of or in conjunction with the transceiver 1314. The apparatus 1300 may optionally include a component for storing information, such as, for example, a memory device/component 1316. The computer readable medium or the memory component 1316 may be operatively coupled to the other components of the apparatus 1300 via the bus 1312 or the like. The memory component 1316 may be adapted to store computer readable instructions and data for effecting the processes and behavior of the components 1302-1306, and subcomponents thereof, or the processor 1310, or the methods disclosed herein. The memory component 1316 may retain instructions for executing functions associated with the components 1302-1306. While shown as being external to the memory 1316, it is to be understood that the components 1302-1306 can exist within the memory 1316.

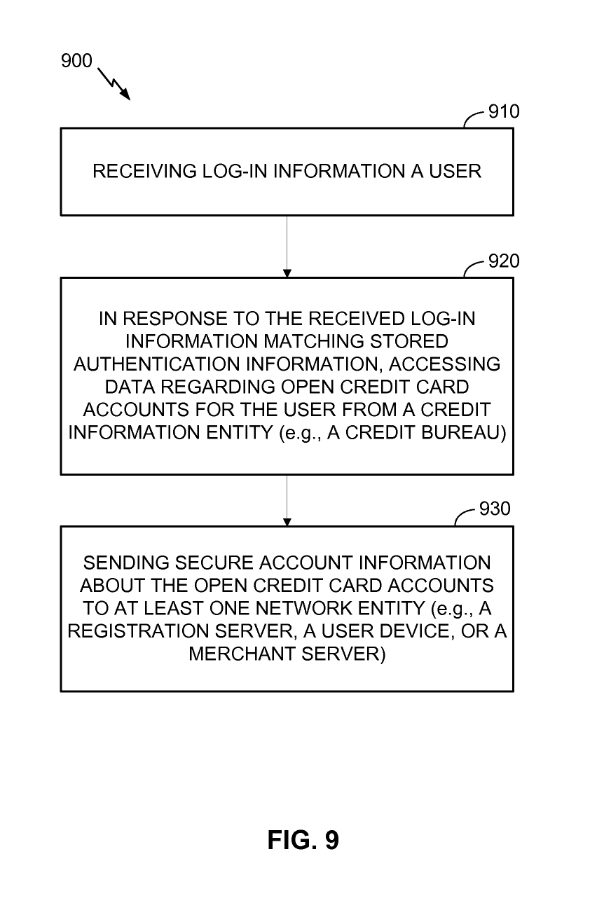

In accordance with one or more aspects of the embodiments described herein, there is provided a methodology operable by an authentication server or the like in an e-commerce network. With reference to FIG. 9, there is shown a method 900 that may involve, at 910, receiving log-in information for a user. The method 900 may involve, at 920, in response to the received log-in information matching stored authentication information, accessing data regarding open credit card accounts for the user from a credit information entity (e.g., a credit bureau). The method 900 may involve, at 930, sending secure account information about the open credit card accounts to at least one network entity (e.g., a registration server, a user device, or a merchant server).

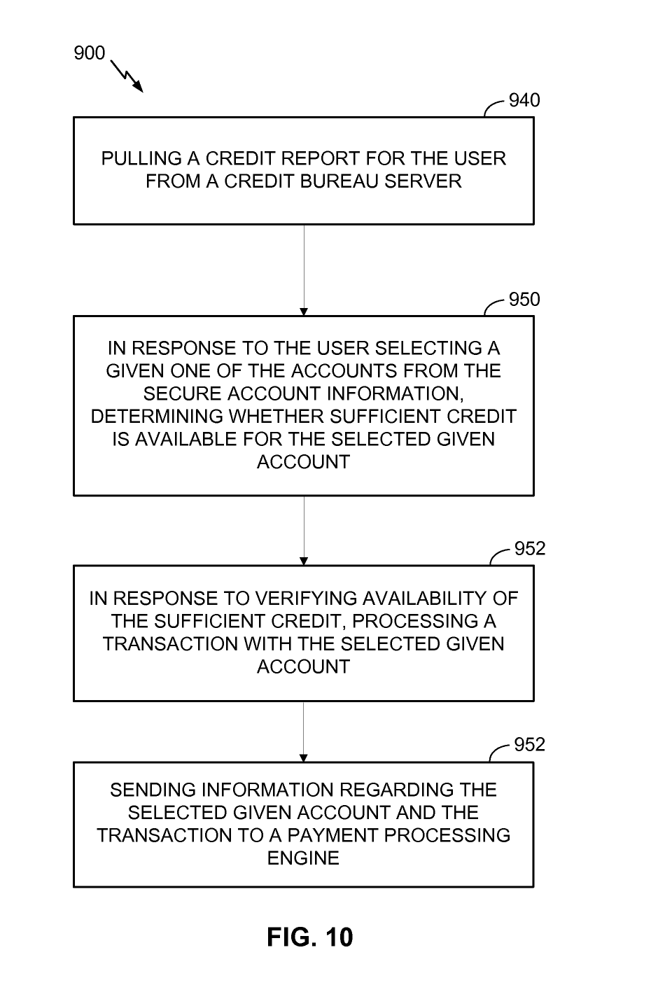

With reference to FIG. 10, accessing may involve, at 940, pulling a credit report for the user from a credit bureau server. The method 900 may involve, at 950, in response to the user selecting a given one of the accounts from the secure account information, determining whether sufficient credit is available for the selected given account. The method 900 may further involve, at 952, in response to verifying availability of the sufficient credit, processing a transaction with the selected given account. Processing the transaction may involve, at 954, sending information regarding the selected given account and the transaction to a payment processing engine.

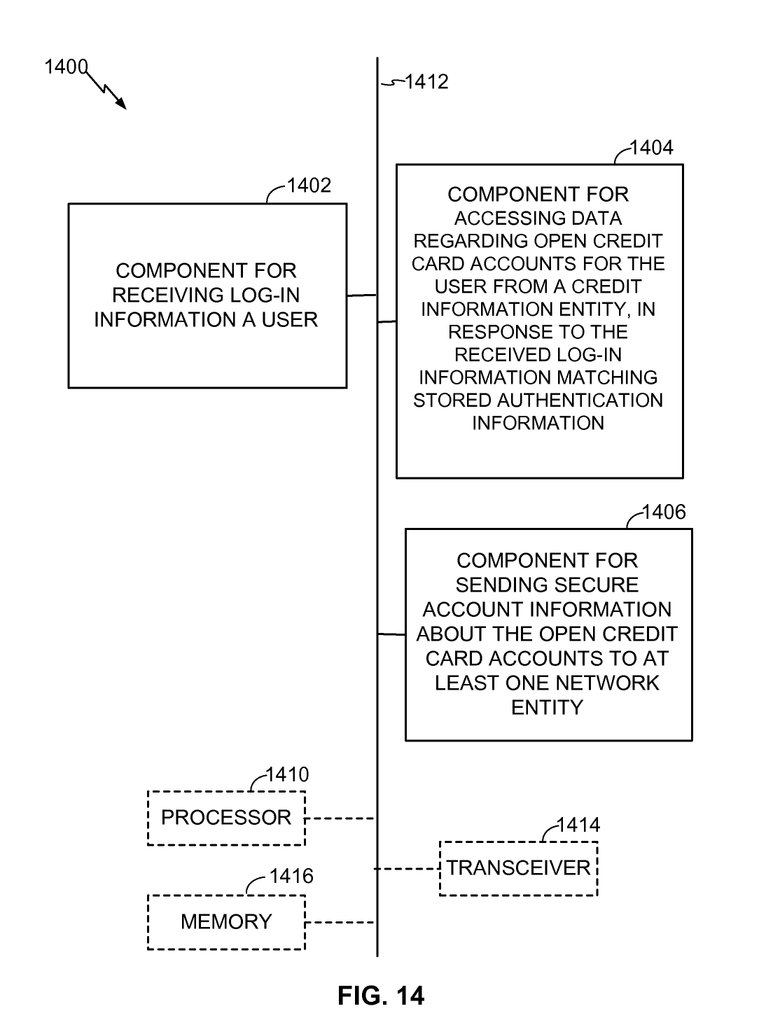

In accordance with one or more aspects of the embodiments described herein, there are provided devices and apparatuses (e.g., authentication servers or components thereof) for secure online payments, as described above with reference to FIGS. 9-10. With reference to FIG. 14, the apparatus 1400 may comprise an electrical component or module 1402 for receiving log-in information for a user. The apparatus 1400 may comprise an electrical component 1404 for accessing data regarding open credit card accounts for the user from a credit information entity, in response to the received log-in information matching stored authentication information. The apparatus 1400 may comprise an electrical component 1406 for sending secure account information about the open credit card accounts to at least one network entity. For the sake of conciseness, the rest of the details regarding apparatus 1400 are not further elaborated on; however, it is to be understood that the remaining features and aspects of the apparatus 1400 are substantially similar to those described above with respect to apparatus 1300 of FIG. 13.

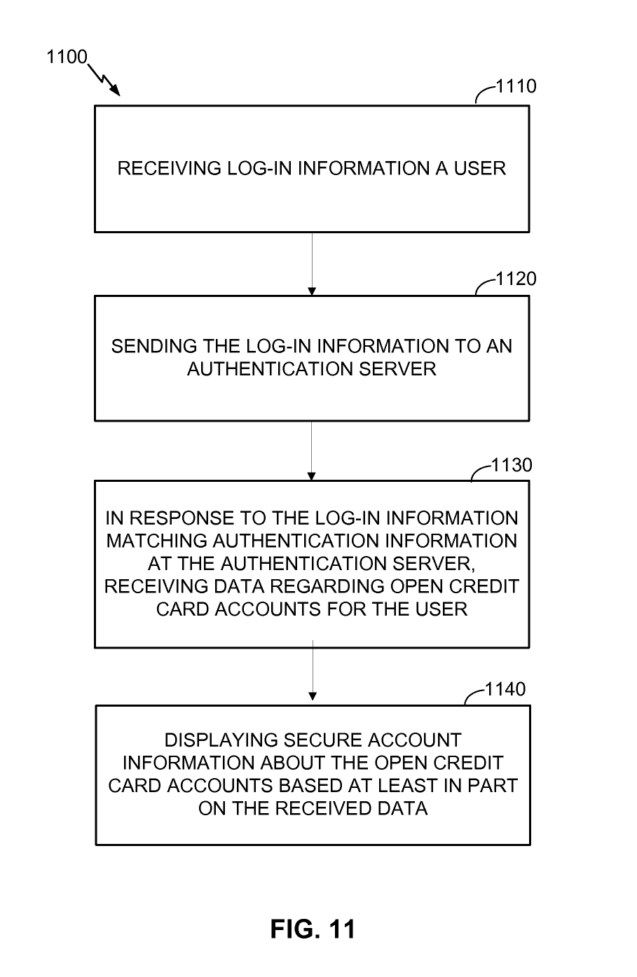

In accordance with one or more aspects of the embodiments described herein, there is provided a methodology operable by a user device. With reference to FIG. 11, there is shown a method 1100 that may involve, at 1110, receiving log-in information from a user. The method 1100 may involve, at 1120, sending the log-in information to an authentication server. The method 1100 may involve, at 1130, in response to the log-in information matching authentication information at the authentication server, receiving data regarding open credit card accounts for the user. The method 1100 may involve, at 1140, displaying secure account information about the open credit card accounts based at least in part on the received data. In related aspects, the received data may be based at least in part on a credit report for the user pulled from a credit bureau server. In further related aspects, the received data may be based at least in part on user-provided information.

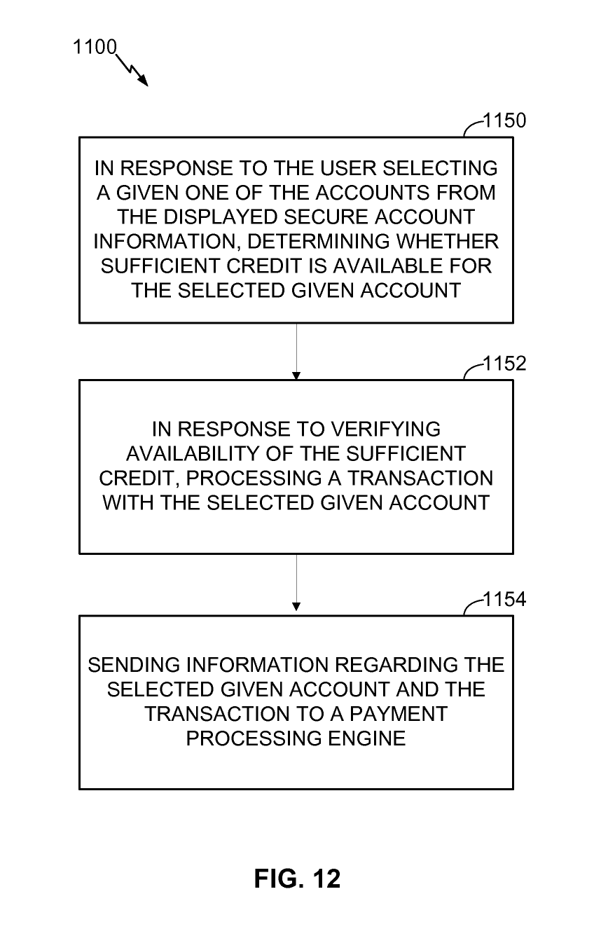

With reference to FIG. 12, the method 1100 may involve, at 1150, in response to the user selecting a given one of the accounts from the displayed secure account information, determining whether sufficient credit is available for the selected given account. The method 1100 may further involve, at 1152, in response to verifying availability of the sufficient credit, processing a transaction with the selected given account. Processing the transaction may involve, at 1154, sending information regarding the selected given account and the transaction to a payment processing engine.

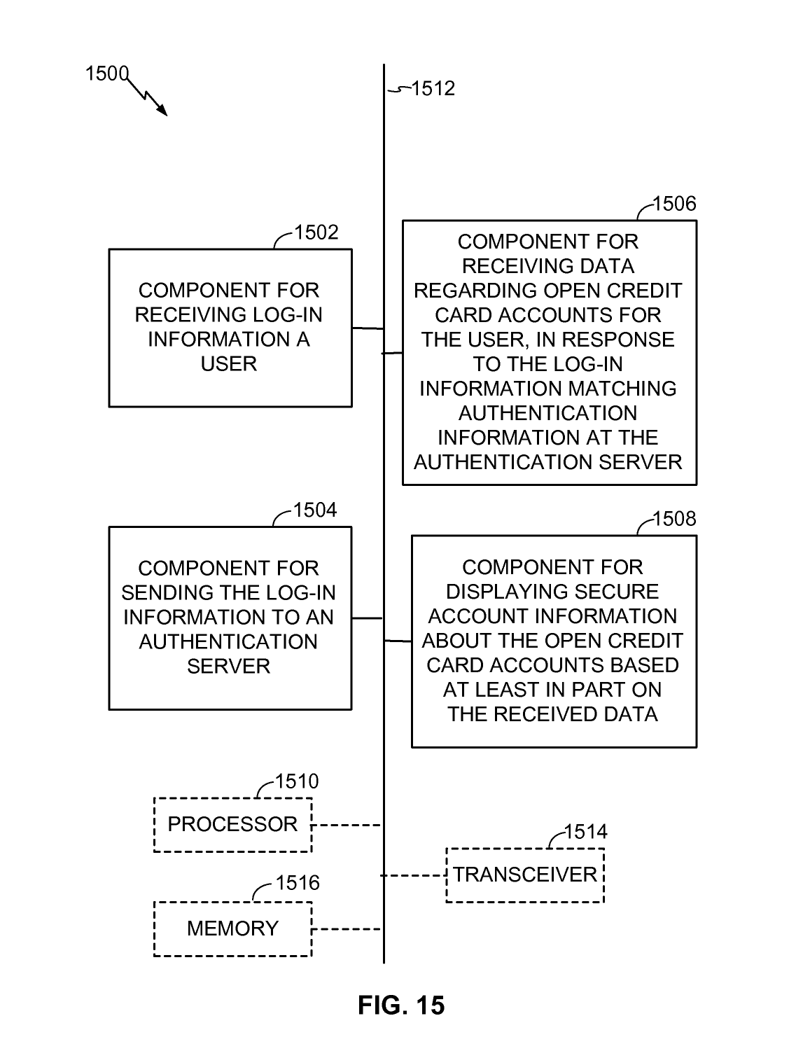

In accordance with one or more aspects of the embodiments described herein, there are provided devices and apparatuses (e.g., user devices or components thereof) for secure online payments, as described above with reference to FIGS. 11-12. With reference to FIG. 15, the apparatus 1500 may comprise an electrical component or module 1502 for receiving log-in information from a user. The apparatus 1500 may comprise an electrical component 1504 for sending the log-in information to an authentication server. The apparatus 1500 may comprise an electrical component 1506 for receiving data regarding open credit card accounts for the user, in response to the log-in information matching authentication information at the authentication server. The apparatus 1500 may comprise an electrical component 1508 for displaying secure account information about the open credit card accounts based at least in part on the received data. For the sake of conciseness, the rest of the details regarding apparatus 1500 are not further elaborated on; however, it is to be understood that the remaining features and aspects of the apparatus 1500 are substantially similar to those described above with respect to apparatus 1300 of FIG. 13.

With reference to FIG. 17, illustrated is another embodiment of a methodology 1700 that may be performed at a registration server or the like in an e-commerce network. The method 1700 may involve, at 1710, receiving registration information from a user. The method 1700 may involve, at 1720, authenticating the user based at least in part on the received registration information. The method 1700 may involve, at 1730, gathering data regarding open credit card accounts for the user from at least one of a credit bureau and a credit card grantor. It is noted that the gathered data may be stored in a database or server (e.g., affiliated or associated with the registration server). An example of such a database or server may be the database/server 1610 shown in FIG. 16.

With reference to FIG. 18, in related aspects, gathering (block 1730) may involve obtaining the data from at least one credit card grantor server or database (block 1732). In further related aspects, gathering (block 1730) may involve accessing the data regarding the open credit card accounts from a credit bureau server or database (block 1734). Gathering the data (block 1730) may further involve accessing, obtaining, requesting, and/or receiving a credit report for the user (block 1740). Accessing the credit report (block 1740) may involve pulling the credit report from a credit bureau server (block 1742). In the alternative, or in addition, gathering (block 1730) may further involve receiving additional data regarding open credit card accounts from the user (i.e., as user-provided information) (block 1750). The method 1700 may further involve displaying secure account information (e.g., a subset of the gathered data and/or truncated versions of credit card numbers for the accounts) about the accounts based at least in part on the gathered data (block 1760).

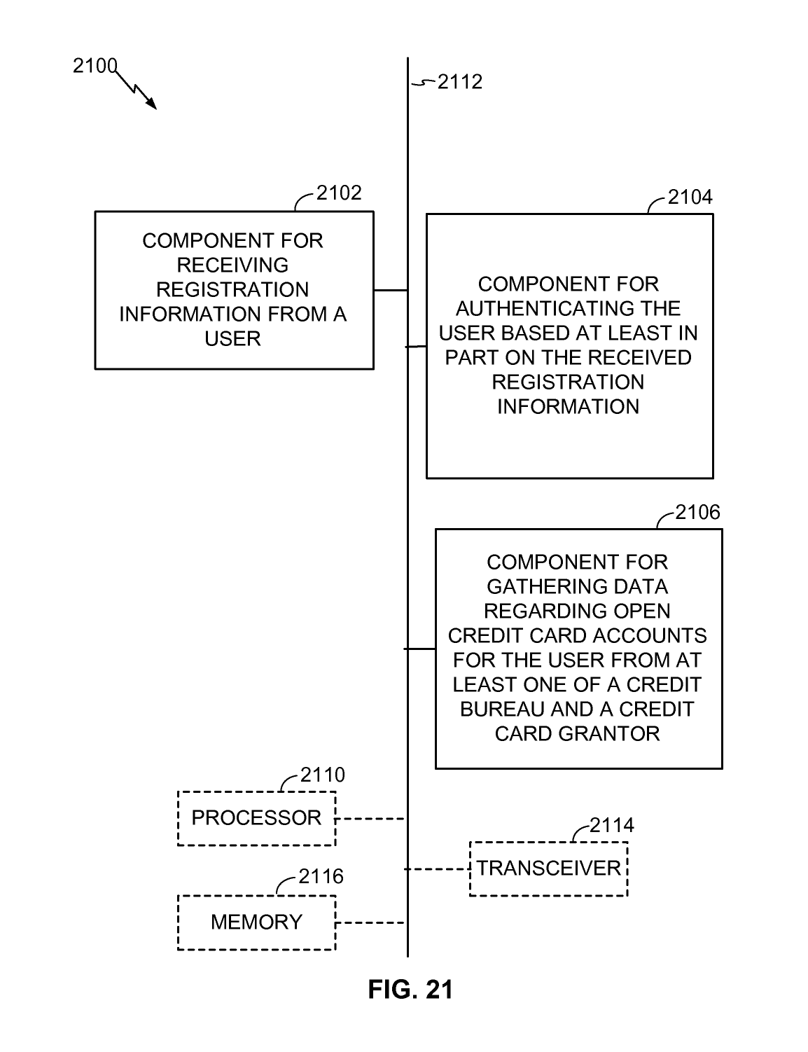

In accordance with one or more aspects of the embodiments described herein, there are provided devices and apparatuses (e.g., registration servers or components thereof) for secure online payments, as described above with reference to FIGS. 17-18. With reference to FIG. 21, the apparatus 2100 may include an electrical component or module 2102 for receiving registration information from a user. The apparatus 2100 may include an electrical component 2104 for authenticating the user based at least in part on the received registration information. The apparatus 2100 may include an electrical component 2106 for gathering data regarding open credit card accounts for the user from at least one of a credit bureau and a credit card grantor. For the sake of conciseness, the rest of the details regarding apparatus 2100 are not further elaborated on; however, it is to be understood that the remaining features and aspects of the apparatus 2100 are substantially similar to those described above with respect to apparatus 1300 of FIG. 13.

With reference to FIG. 19, illustrated is another embodiment of a methodology 1900 that may be performed at an authentication server or the like in an e-commerce network. The method 1900 may involve, at 1910, receiving log-in information for a user. The method 1900 may involve, at 1920, in response to the received log-in information matching stored authentication information, accessing data regarding open credit card accounts for the user from at least one of a credit bureau and a credit card grantor. The accessed data may be stored in a database/server (e.g., database/server 1610 shown in FIG. 16), which may or may not be associated with the authentication server. The method 1900 may involve, at 1930, sending secure account information about the open credit card accounts to at least one network entity (e.g., a registration server, a user device, a merchant server, or the like).

With reference to FIG. 20, in related aspects, accessing (block 1920) may involve at least one of pulling a credit report for the user from a credit bureau server and obtaining credit card information for the user from at least one credit card grantor server (block 1940). The accessed additional data from the credit bureau may be stored in the database/server (e.g., database/server 1610 shown in FIG. 16) either in conjunction with or in lieu of the data from the credit card grantor/issuer. In further related aspects, the method 1900 may involve, in response to the user selecting a given one of the accounts from the secure account information, determining whether sufficient credit is available for the selected given account (block 1950). The method 1900 may also involve, in response to verifying availability of the sufficient credit, processing a transaction with the selected given account (block 1952).

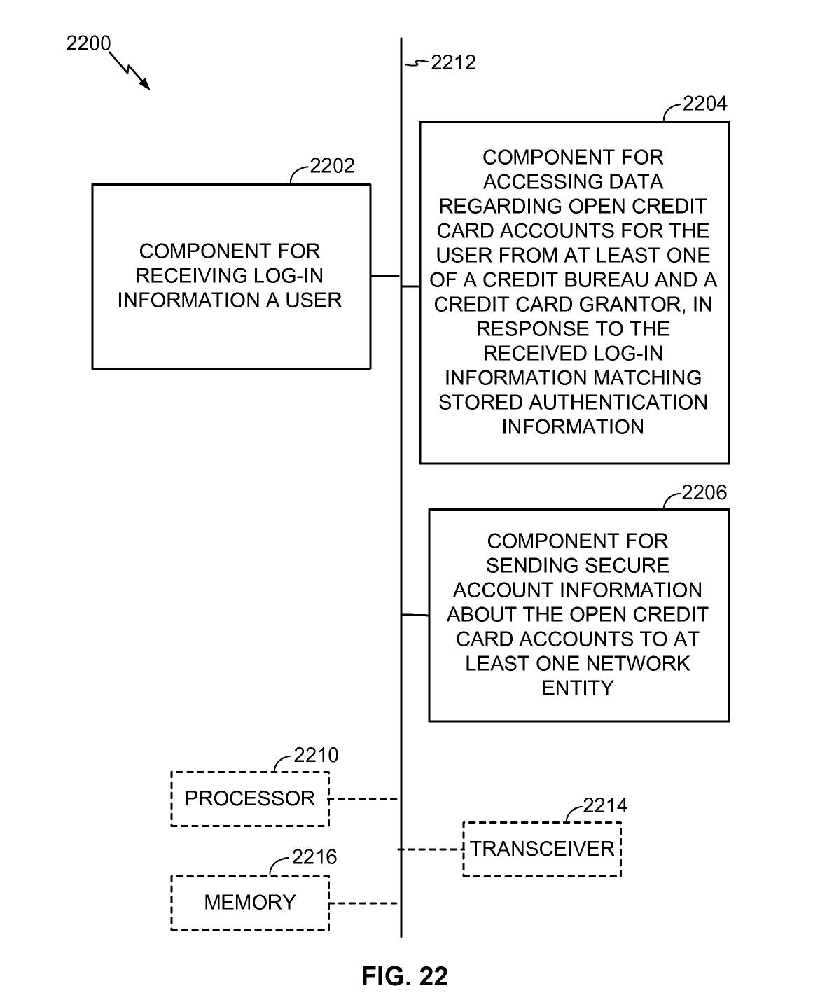

In accordance with one or more aspects of the embodiments described herein, there are provided devices and apparatuses (e.g., authentication servers or components thereof) for secure online payments, as described above with reference to FIGS. 19-20. With reference to FIG. 22, the apparatus 2200 may include an electrical component or module 2202 for receiving log-in information for a user. The apparatus 2200 may include an electrical component 2204 for in response to the received log-in information matching stored authentication information, accessing data regarding open credit card accounts for the user from at least one of a credit bureau and a credit card grantor. The apparatus 2200 may include an electrical component 2206 for sending secure account information about the open credit card accounts to at least one network entity. For the sake of conciseness, the rest of the details regarding apparatus 2200 are not further elaborated on; however, it is to be understood that the remaining features and aspects of the apparatus 2200 are substantially similar to those described above with respect to apparatus 1300 of FIG. 13.

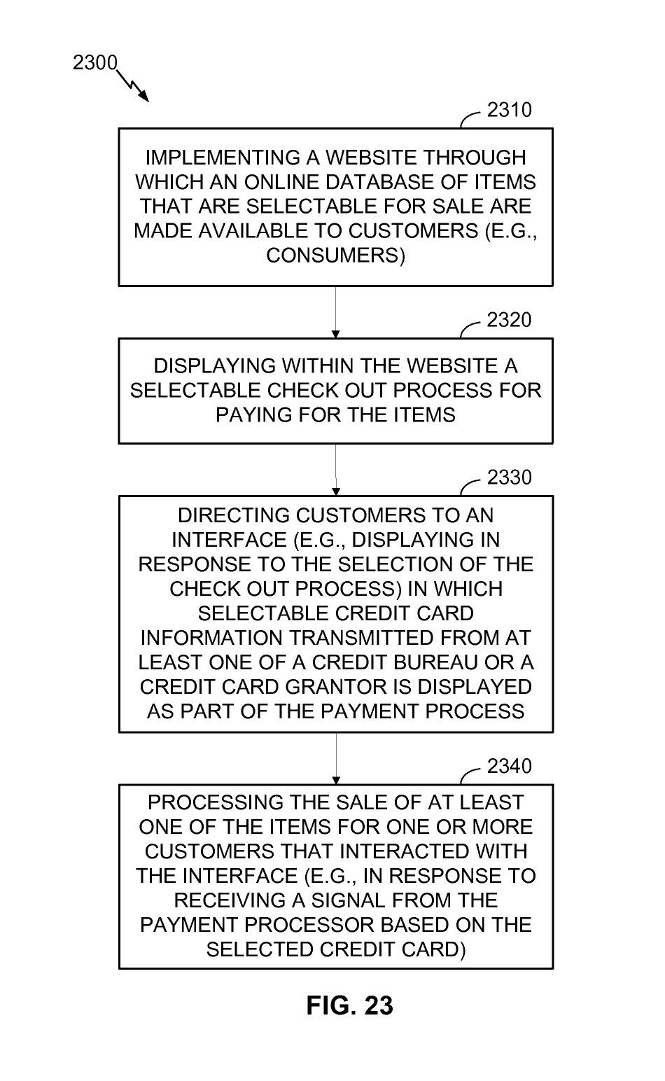

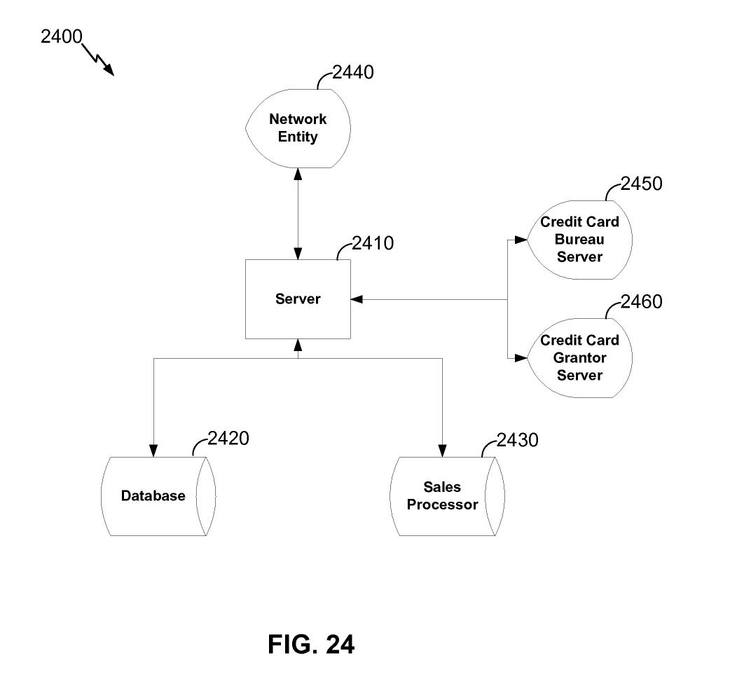

With reference to FIG. 23, illustrated is another embodiment of a methodology 2300 that may be performed at a merchant's website server or the like in an e-commerce network. The method 2300 may involve, at 2310, implementing a website through which an online database of items that are selectable for sale are made available to customers (e.g., online consumers). The method 2300 may involve, at 2320, displaying within the website a selectable check out process for paying for the items. The check out process can include and display a third party payment service as an option for its customers. The service could be one of multiple third party payments services that the merchant makes available within its website. The method 2300 may involve, at 2330, directing customers (e.g., by way a link or selectable code within a display screen within the merchant's website or within its check out process) to an interface in which selectable credit card information communicated from at least one of a credit bureau or a credit card grantor to the third party service is displayed as part of the overall check out process. For example, directing customers to the interface may occur in response to the selection of the particular payment processing service. The option can include one or more links or executable software that is configured to connect the merchant's checkout process with the selected third party service. When selected, for example, the merchant's website can send data such as a transaction amount for a purchase to the third party service and may wait for a response message from a third party checkout service or other resource before permitting the merchandise to be purchased. The method 2300 may involve, at 2340, processing the sale of at least one of the items for one or more consumers that interacted with the interface. Payment processing may be performed by software and/or hardware implemented by the payment processing service or the payment processing service can send one or messages (e.g., containing amount information and credit card details such number and expiration) to an external payment processor. It is noted that the online database of items may be stored in a database or server (e.g., affiliated or associated with the merchant's website server). The processing may occur in response to receiving a signal from a payment processor, indirectly or directly, based on a selected credit card. An example of a system for implementing method 2300 is shown in FIG. 24. For example, the checkout process may be the process illustratively described herein, such as in connection with FIGS. 2A and 2B, which is implemented by a merchant on their website for their use in selling items. Each illustrated communications connection can be over the same or different networks (e.g., Internet, Internet and private communications networks). One or more of the communications connections can be across a network. The service can for example handle credit cards from many different credit card companies, which provides greater flexibility to merchants and customers.

In one or more exemplary embodiments, the source of credit card data may be a credit bureau server or a credit card grantor server. Many credit bureaus currently exist which serve the function of providing a credit report that may contain financial details of an individual's credit cards or other credit related accounts. A credit report may typically include a credit rating for an individual. A computer system at the credit bureau, such as a server may be able to receive or obtain access to credit information from credit providers, store the credit information, process and compile the credit information, generate ratings, and distribute (e.g., communicating through various different means) to those that requested a credit report. The credit reports may have different structures and content. The credit bureau may receive or obtain an update of credit card data on some recurring basis (e.g., from the credit card grantor's servers). A credit report typically may include specific details of individual credit cards, loans, payment history, loan amounts, remaining balances, and other specific third party account information. Typically, credit card bureaus are not involved in payment processing for transaction of goods or services. They aggregate data and provide reports and update their data on some recurring basis from third parties sources. A credit card grantor may also have electronic resources such as a server that is implemented to provide data about credit cards that are granted by that company. Data regarding the current or recent specifics of credit card accounts or credit accounts held with that grantor are owned and stored securely by that credit card grantor such as on their servers. The data may provide specifics of credit card accounts such as available balance, number of different cards issued by a grantor to a particular customer, or possibly other information that can be used by a payment processor or be used to correlate to stored personal data that can be used by a payment processor.

The third party payment service may not have access to live credit card account information of a user because the service is not responsible for maintaining user's credit card accounts. The server or other equipment of a credit card company maintains one or more credit card accounts and generates “live” credit card data for those accounts (e.g., as transactions are received). A credit card company may provide a secure website for its customers that is configured to display that credit card holder's credit card information, e.g., recent activity, account balance, etc. A credit card company may implement a service in which it provides such credit card information to a third party such as the third party checkout service (e.g., an entity that is authorized by the credit card holder to receive such information). For example, credit card data is generated (e.g., resulting from a new transaction that affects the available credit) and is distributed (e.g., on request, broadcast, periodically etc.) to the third party payment service. In some embodiments, the third party checkout service or system may receive data and stores credit card data that may be different than the corresponding credit card data stored at that time at a credit card grantor server(s) (or credit card bureau server(s)) depending on when the last communication (e.g., update message(s)) was received from the credit card grantor(s) (or credit bureau server(s)).

Many different merchants can link their sites with the service to gain the benefit of an additional check out option for their customers. The process or system can display credit card details for users (e.g., registered users) using third party software and hardware (external to the merchant's website and/or credit card company's network site) such as to avoid providing or passing the user's information on or through the merchant's website. The process can permit individuals to charge transactions directly to their credit card. The process or system can be independent such that it receives credit card data from one source, transaction data from another source, and stores that information for later retrieval or display. The stored information can be displayed through a website such as displayed to a registered user and the display can provide a transaction history containing one or more details of individual transactions including an identification of a credit card (or multiple different credit cards, from different grantors) and identification of one or more different merchants. A third source of data can be information from a user. Possibly a fourth source of data that is also received and stored is information from a payment processing service (e.g., a network address with which there was interaction to process a payment using a credit card selected in the third party checkout service). The data received from the different sources is stored in a database in structural association with individual users and corresponding transactions.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, non-transitory signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Moreover, protocols that may be used over any such connection to communicate messages, include SOAP, Secure SOAP, XML, SMTP, HTTP, HTTPS, TLS, SSL, SSH, SFTP, VPN, MPLS, Experian NetConnect, Equifax Internet STS Connectivity, and TransUnion Net Access, are included in the definition of medium. Disk and disc, as used herein, includes Compact Disc (CD), laser disc, optical disc, Digital Versatile Disc (DVD), floppy disk and blu-ray disc where disks usually reproduce data magnetically, while discs reproduce data optically with lasers. Combinations of the above should also be included within the scope of computer-readable media.

If desired other forms of payment can be displayed with credit cards as part of the check out or payment process.

It would be understood by those of ordinary skill in the art that a communication between network entities such as two servers involves sending and receiving one or more network messages.

It would be understood by those of ordinary skill in the art that the use of “first,” “second,” “third,” in describing one or more communication herein does not necessarily imply an order of performance. In addition, in one or more exemplary embodiments, it is not necessary for all such communications to traverse the same medium. For example, some communications may occur only over a secure or non-public network, while others traverse the Internet.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A secure online payment method operable by an e-commerce server, comprising:
receiving a first communication from at least one of a credit bureau server or a credit card grantor server, wherein the first communication contains credit card data comprising information regarding credit card accounts of a user;
sending a second communication containing account information based at least in part on the credit card data to at least one network entity;
receiving a third communication containing a selection of one of the credit card accounts of the user; and
sending a fourth communication containing transaction information including the selected credit card account to a payment processor.

2. The method of claim 1, wherein the credit card data comprises a credit report regarding the user.

3. The method of claim 1, wherein the information regarding the credit card accounts of the user comprises at least one of a credit card number, expiration date, security code, cardholder name, or billing address for each credit card account of the user.

4. The method of claim 1, wherein the account information for each of the credit card accounts of the user contains a portion of a credit card number and information representative of a current balance associated with the credit card account.

5. The method of claim 1, wherein the account information if intercepted requires the credit card data not contained in the account information to enable a payment transaction using at least one credit card account of the user.

6. The method of claim 1, wherein the account information does not contain at least one of a credit card number, expiration date, security code, cardholder name, or billing address of a credit card account of the user.

7. The method of claim 1, further comprising receiving a fifth communication containing a response by the payment processor.

8. The method of claim 1, further comprising:
receiving a fifth communication containing registration information identifying the user;
performing authentication based at least in part on the registration information; and
sending a sixth communication containing a request for the credit card data to at least one of the credit bureau server or the credit card grantor server.

9. The method of claim 1, wherein sending the second communication containing the account information further comprises:
displaying an interface containing one or more credit card accounts of the user based on the account information, wherein the interface is configured to allow the user to select one of the credit card accounts of the user to process a transaction.

10. The method of claim 1, wherein the first communication is not communicated over a publicly accessible network including the Internet.

11. An apparatus, comprising:
at least one processor configured to: receive a first communication from at least one of a credit bureau server or a credit card grantor server, wherein the first communication contains credit card data comprising information regarding credit card accounts of a user; send a second communication containing account information based at least in part on the credit card data to at least one network entity; receive a third communication containing a selection of one of the credit card accounts of the user; and send a fourth communication containing transaction information including the selected credit card account to a payment processor; and
a memory coupled to the at least one processor for storing the credit card data, the account information, the selected credit card account, and the transaction information.

12. The apparatus of claim 11, wherein the credit card data comprises a credit report regarding the user.

13. The apparatus of claim 11, wherein the information regarding the credit card accounts of the user comprises at least one of a credit card number, expiration date, security code, cardholder name, or billing address for each credit card account of the user.

14. The apparatus of claim 11, wherein the account information for each of the credit card accounts of the user contains a portion of a credit card number and information representative of a current balance associated with the credit card account.

15. The apparatus of claim 11, wherein the account information if intercepted requires the credit card data not contained in the account information to enable a payment transaction using at least one credit card account of the user.

16. The apparatus of claim 11, wherein the account information does not contain at least one of a credit card number, expiration date, security code, cardholder name, or billing address of a credit card account of the user.

17. The apparatus of claim 11, wherein the at least one processor is further configured to: receive a fifth communication containing registration information identifying the user; perform authentication based at least in part on the registration information; and send a sixth communication containing a request for the credit card data to at least one of the credit bureau server or the credit card grantor server; and the memory coupled to the at least one processor is further configured for storing the registration information and the request.

18. The apparatus of claim 11, wherein the at least one processor is further configured to receive a fifth communication containing a response by the payment processor and the memory coupled to the at least one processor is further configured for storing the response by the payment processor.

19. The apparatus of claim 11, wherein to send the second communication containing the account information the at least one processor is further configured to display an interface containing one or more credit card accounts of the user based on the account information, wherein the interface is configured to allow the user to select one of the credit card accounts of the user to process a transaction; and the memory coupled to the at least one processer is further configured for storing the interface.

20. The apparatus of claim 11, wherein the first communication is not communicated over a publicly accessible network including the Internet.

21. A computer program product, comprising:
a computer-readable medium comprising code for causing a computer to:
receive a first communication from to at least one of a credit bureau server or a credit card grantor server, wherein the first communication contains credit card data comprising information regarding credit card accounts of a user;
send a second communication containing account information based at least in part on the credit card data to at least one network entity;
receive a third communication containing a selection of one of the credit card accounts of the user; and
send a fourth communication containing transaction information including the selected credit card account to a payment processor.

22. The computer program product of claim 21, wherein the credit card data comprises a credit report regarding the user.

23. The computer program product of claim 21, wherein the information regarding the credit card accounts of the user comprises at least one of a credit card number, expiration date, security code, cardholder name, or billing address for each credit card account of the user.

24. The computer program product of claim 21, wherein the account information for each of the credit card accounts of the user contains a portion of a credit card number and information representative of a current balance associated with the credit card account.

25. The computer program product of claim 21, wherein the account information if intercepted requires the credit card data not contained in the account information to enable a payment transaction using at least one credit card account of the user.

26. The computer program product of claim 21, wherein the account information does not contain at least one of a credit card number, expiration date, security code, cardholder name, or billing address of a credit card account of the user.

27. The computer program product of claim 21, wherein the computer-readable medium further comprises code for causing the computer to:
receive a fifth communication containing registration information identifying the user;
perform authentication based at least in part on the registration information; and
send a sixth communication containing a request for the credit card data to at least one of the credit bureau server or the credit card grantor server.

28. The computer program product of claim 21, wherein the computer-readable medium further comprises code for causing the computer to receive a fifth communication containing a response from the payment processor.

29. The computer program product of claim 21, wherein to send the second communication containing the account information the computer-readable medium further comprises code for causing a computer to display an interface containing one or more credit card accounts of the user based on the account information, wherein the interface is configured to allow the user to select one of the credit card accounts of the user to process a transaction.

30. The computer program product of claim 21, wherein the first communication is not communicated over a publicly accessible network including the Internet.

31. An apparatus, comprising:
at least one processor configured to:
receive a first communication containing a request to use a payment service; and
send a second communication containing transaction information to a payment service, wherein the payment service in response to the second communication is configured automatically to:
receive a third communication from at least one of a credit bureau server or a credit card grantor server, wherein the third communication contains credit card data comprising information regarding credit card accounts of a user; send a fourth communication containing account information based at least in part on the credit card data to at least one network entity; receive a fifth communication containing a selection of one of the credit card accounts of the user; send a sixth communication containing transaction information including the selected credit card account to a payment processor; and receive a seventh communication containing a response from the payment processor; and
a memory coupled to the at least one processor for storing the request to use the payment service and the transaction information.

32. The apparatus of claim 31, wherein the credit card data comprises a credit report regarding the user.

33. The apparatus of claim 31, wherein the information regarding the credit card accounts of the user comprises at least one of a credit card number, expiration date, security code, cardholder name, or billing address for each credit card account of the user.

34. The apparatus of claim 31, wherein the account information for each of the credit card accounts of the user contains a portion of a credit card number and information representative of a current balance associated with the credit card account.

35. The apparatus of claim 31, wherein the account information if intercepted requires the credit card data not contained in the account information to enable a payment transaction using at least one credit card account of the user.

36. The apparatus of claim 31, wherein the account information does not contain at least one of a credit card number, expiration date, security code, cardholder name, or billing address of a credit card account of the user.

37. The apparatus of claim 31, wherein the payment service in response to the second communication is further configured automatically to:
receive an eighth communication containing registration information identifying the user;
perform authentication based at least in part on the registration information; and
send a ninth communication containing a request for the credit card data to at least one of the credit bureau server or the credit card grantor server.

38. The apparatus of claim 31, wherein to send the fourth communication containing the account information the payment service is further configured automatically to display an interface containing one or more credit card accounts of the user based on the account information, wherein the interface is configured to allow the user to select one of the credit card accounts of the user to process a transaction.

39. A method of performing online sales transactions with consumers, comprising:
implementing a website through which an online database of items that are selectable for sale are made available to consumers;
implementing within the website a selectable check out process for paying for the items;
directing consumers to an interface in which selectable credit card information communicated from at least one of a credit bureau or a credit card grantor is displayed as part of the check out process; and
processing the sale of at least one of the items for one or more consumers that interacted with the interface.

40. The method of claim 39, wherein the website comprises one or more applets.

41. The method of claim 39, wherein the selectable credit card information does not contain at least one of a credit card number, expiration date, security code, cardholder name, or billing address of a credit card account of the user.

42. The method of claim 39, wherein the selectable credit card information contains at least one of a card name, a masked or abbreviated card number, an account status, current balance, or current payment amount.

43. The method of claim 39, wherein the selectable credit card information for each credit card account of the user contains a portion of a credit card number and information representative of a current balance associated with the credit card account.

44. A system for performing online sales transactions with consumers, comprising
a database of items that are selectable for sale to the consumers;
a server capable of implementing a website through which the online database of items that are selectable for sale are made available to the consumers, implementing within the website a selectable check out process for paying for the items, and directing consumers to an interface in which selectable credit card information communicated from at least one of a credit bureau or a credit card grantor is displayed as part of the check out process; and
a sales processor component for processing the sale of at least one of the items for one or more consumers that interacted with the interface.

45. The system of claim 44, wherein the website comprises one or more applets.

46. The system of claim 44, wherein the selectable credit card information does not contain at least one of a credit card number, expiration date, security code, cardholder name, or billing address of a credit card account of the user.

47. The system of claim 44, wherein the selectable credit card information contains at least one of a card name, a masked or abbreviated card number, an account status, current balance, or current payment amount.

48. The method of claim 44, wherein the selectable credit card information for each credit card account of the user contains a portion of a credit card number and information representative of a current balance associated with the credit card account.

49. A secure online payment method operable by a registration server, comprising:
receiving a first communication containing registration information identifying a user;
performing authentication based at least in part on the registration information; and
receiving a second communication containing credit card data regarding one or more open credit card accounts of the user from at least one of a credit bureau or a credit card grantor.

50. The method of claim 49, wherein the credit card data is based at least in part on a credit report relating to the user.

51. The method of claim 49, wherein receiving the second communication further comprises receiving the second communication from at least one credit bureau server.

52. The method of claim 49, further comprising receiving a third communication containing information from the user regarding the one or more open credit card accounts.

53. The method of claim 49, wherein receiving the second communication further comprises receiving the second communication from at least one credit card grantor server.

54. The method of claim 49, further comprising displaying account information based at least in part on the credit card data.

55. An apparatus, comprising:
at least one processor configured to: receive a first communication containing registration information identifying a user; perform authentication based at least in part on the registration information; and receive a second communication containing credit card data regarding one or more open credit card accounts of the user from at least one of a credit bureau or a credit card grantor; and
a memory coupled to the at least one processor for storing the registration information and the credit card data.

56. The apparatus of claim 55, wherein the credit card data is based at least in part on a credit report relating to the user.

57. The apparatus of claim 55, wherein the at least one processor is further configured to receive a third communication containing information from the user regarding the one or more open credit card accounts and the memory coupled to the at least one processor is further configured for storing the information from the user.

58. A computer program product, comprising:
a computer-readable medium comprising code for causing a computer to:
receive a first communication containing registration information identifying a user;
performing authentication based at least in part on the registration information; and
receive a second communication containing credit card data regarding one or more open credit card accounts of the user from at least one of a credit bureau or a credit card grantor.

59. The computer program product of claim 58, wherein the computer-readable medium further comprises code for causing the computer to send a third communication containing a request for credit card data to at least one of a credit bureau server or a credit card grantor server.

60. A secure online payment method operable by an authentication server, comprising:
receiving a first communication containing log-in information identifying a user;
matching the log-in information with stored authentication information;
receiving a second communication containing credit card data regarding open credit card accounts of the user from at least one of a credit bureau or a credit card grantor; and
sending a third communication containing account information based at least in part on the credit card data to at least one network entity.

61. The method of claim 60, wherein the credit card data is based at least in part on a credit report relating to the user.

62. The method of claim 60, further comprising receiving a fourth communication containing information from the user regarding the one or more open credit card accounts

63. The method of claim 60, wherein the at least one network entity comprises one of a registration server, a user device, and a merchant server.

64. The method of claim 60, further comprising:
in response to a fourth communication containing a selection of a credit card account from the account information, determining whether sufficient credit is available for the selected credit card account; and
in response to verifying availability of the sufficient credit, processing a transaction with the selected credit card account.

65. An apparatus, comprising:
at least one processor configured to: receive a first communication containing log-in information identifying a user; match the log-in information with stored authentication information; receive a second communication containing credit card data regarding open credit card accounts of the user from at least one of a credit bureau or a credit card grantor; and send a third communication containing account information based at least in part on the credit card data to at least one network entity; and
a memory coupled to the at least one processor for storing log-in information, authentication information, credit card data, and account information.

66. The apparatus of claim 65, wherein the at least one processor is further configured to send a fourth communication containing a request for credit card data to at least one of a credit bureau server or a credit card grantor server and the memory coupled to the at least one processor is further configured for storing the request.

67. A computer program product, comprising:
a computer-readable medium comprising code for causing a computer to:
receive a first communication containing log-in information identifying a user;
match the log-in information with stored authentication information;
receive a second communication containing credit card data regarding open credit card accounts of the user from at least one of a credit bureau or a credit card grantor; and
send a third communication containing account information based at least in part on the credit card data to at least one network entity.

68. The computer program product of claim 67, wherein the computer-readable medium further comprises code for causing the computer to send a fourth communication containing a request for credit card data to at least one of a credit bureau server or a credit card grantor server.
